(19) United States
(12) Patent Application Publication
(10) Pub. No.: US 2026/0014512 A1
(43) Pub. Date: Jan. 15, 2026

(54) COVALENT ORGANIC FRAMEWORKS FOR GAS CHROMATOGRAPHIC SEPARATIONS

(71) Applicants: Northwestern University, Evanston, IL (US); King Saud University, Riyadh (SA)

(72) Inventors: William Robert Dichtel, Evanston, IL (US); Anusree Natraj, Evanston, IL (US); Woojung Ji, Evanston, IL (US); Kareem Y. Mahmoud, Evanston, IL (US); Mohamed Ateia Ibrahim, Evanston, IL (US)

(21) Appl. No.: 18/993,932

(22) PCT Filed: Jul. 13, 2023
(86) PCT No.: PCT/US2023/070171

§ 371 Date: Jan. 13, 2025

Related U.S. Application Data
(60) Provisional application No. 63/368,349, filed on Jul. 13, 2022.

(51) Int. Cl. B01D 53/02; B01J 20/26

(52) U.S. Cl. CPC B01D 53/025; B01J 20/264; B01D 2253/202; B01D 2257/702; B01J 2220/84

(57) ABSTRACT

Disclosed herein are single crystal imine-linked 2D-covalent organic frameworks (COFs), methods of making and using the same. In some embodiments, the imine-linked 2D-covalent organic frameworks are used to separate a mixture.

### CROSS-REFERENCE TO RELATED APPLICATIONS

This application claims benefit of priority to U.S. Application Ser. No. 63/368,349, filed Jul. 13, 2022, the contents of which is incorporated herein by reference in its entirety.

### STATEMENT REGARDING FEDERALLY SPONSORED RESEARCH

This invention was made with government support under DMR-1720139 awarded by the National Science Foundation and W911NF-15-1-0447 awarded by the Department of Defense. The government has certain rights in the invention.

### BACKGROUND OF THE INVENTION

The polymerization of monomers into two-dimensional (2D) macromolecular sheets is a longstanding synthetic challenge that will provide organic materials with distinct properties compared to traditional polymer architectures. Direct, solution-based polymerizations provide 2D polymers (2DPs) often known as 2D covalent organic frameworks (COFs), which have shown properties of interest for catalysis, sensing, membranes, gas storage and separation, adsorbents, energy storage, and optoelectronic devices. These applications leverage the precise and tunable structures, permanent nanometer-scale porosity, and layered structures associated with 2D COFs or other 2DPs. However, rather than forming the macromolecular sheets with macro- or mesoscale crystalline domains, most COF polymerizations yield insoluble, polycrystalline powders with domain lengths smaller than 100 nm in the plane of the 2D sheet. These isolated forms and crystalline domain sizes often limit the full extent of physical properties of the 2D COFs, along with their practical relevance for otherwise promising applications. Therefore, general and operationally simple methods to obtain 2D COFs with larger crystalline domain sizes and improved processibility remain an important frontier in their development.

### SUMMARY OF THE INVENTION

Disclosed herein are single crystal imine-linked 2D-covalent organic frameworks (COFs), methods of making and using the same. In some embodiments, the imine-linked 2D-COFs are used to separate a mixture. The imine-linked 2D-COFs form platelets having lateral dimensions of at least 400 nm. The platelets comprises a multiplicity of crystals of an imine-linked 2D-COF oriented with inter-sheet stacking in a direction out-of-plane with the lateral dimensions and wherein each of the multiplicity of crystals of imine-linked 2D-COF comprise a substantially single-crystalline domain. Examples include a 1,3,6,8-tetrakis(4-aminophenyl)pyrene and terephthalaldehyde (TAPPy-PDA) COF or a 1,3,5-tris(4-aminophenyl)benzene and 2,5-dimethoxyterephthalaldehyde (TAPD-BMPDA) COF. Columns and gas chromatographs incorporating the COF placements described herein may be used to separate mixtures because of the preferential adsorption of one component of the mixture over another by the COF platelet. Notably, polycrystalline samples can lack the ability to separate the components.

Another aspect of the technology provides for methods of making the COF platelets described herein. The COF platelets may be prepared by contacting a building unit and a linking group in a nitrile-containing solvent in the presence of a modulator of polymerization and catalyst for defect correction, wherein the building unit comprises a molecular subunit having two or more functional termini that covalently bond via an imine bond with an equal number of linking groups.

Another aspect of the technology provides for methods for separating a mixture by contacting the mixture with any of the COF platelets described herein. Suitably, the mixture may contain benzene and cyclohexane and the COF platelet may allow for effective separation of one component from another.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1. Synthesis of single-crystalline imine-linked (A) TAPPy-PDA and (B) TAPB-DMPDA COFs.

FIG. 2. (A) Experimental and simulated PXRD patterns (AA stacking), (B) N₂ adsorption and desorption isotherms, and (C) NLDFT pore width distribution of 1 μm-sized TAPPy-PDA COF single crystals. (D) Experimental and simulated PXRD patterns (AA stacking), (E) N₂ adsorption and desorption isotherms, and (F)NLDFT pore width distribution of 1 m-sized TAPB-DMPDA COF single crystals.

FIG. 3. (A) SEM and (B) HRTEM images of 1 m-sized TAPPy-PDA COF single crystals with dashed lines drawn around the edges of the crystal as a guide to the eye. (C) Lattice-resolution HRTEM image of the boxed region in (B), which shows lattice fringes that extend across the entire crystal, and (D) a bandpass-filtered image of (C) with enhanced contrast. (E) FFT of the boxed region in (B), with spots circled (blue, orange) that correspond to d₁₀₀ spacings of 23.9 and 24.0 Å, respectively. (F) SEM and (G) HRTEM images of 1 μm-sized TAPB-DMPDA COF single crystals with dashed lines drawn around the edges of the crystal as a guide to the eye. (H) Lattice-resolution HRTEM images of the boxed region in (G), which shows lattice fringes that extend across the entire crystal, and (I) a bandpass-filtered image of (H) with enhanced contrast. (J) FFT of the boxed region in (G), with spots circled (blue, orange, and green) that correspond to d₁₀₀ spacings of 31.4, 31.1 and 31.5 Å, respectively.

FIG. 4. 3D reciprocal lattices of (A) and (B) TAPPy-PDA COF at 4.4 Å resolution and (D) and (E) TAPB-DMPDA COF at 4 Å resolution, as determined by low-dose cRED. (C) and (F) show Rietveld refinements for TAPPy-PDA and TAPB-DMPDA COFs, respectively, with TAPPy-PDA COF having refinement parameters Rₚ=5.50% and R_{wp}=8.37%, and TAPB-DMPDA COF having refinement parameters Rₚ=4.77% and R_{wp}=6.71%.

FIG. 5. Layer offset directions of (A) TAPPy-PDA and (D) TAPB-DMPDA COFs, respectively. DIFFaX-simulated PXRD patterns from average eclipsed (AA) stacking (bottom-most trace) to random stacking (trace under experimental PXRD pattern) for (B) and (C) TAPPy-PDA COF, and (E) and (F) TAPB-DMPDA COF.

FIG. 6. Gas chromatography separation performance of capillary columns (20 μm length, 0.25 mm i.d.) coated with TAPPy-PDA COF (single and polycrystalline) and commercial standard TR-5MS column of the same dimensions. Data recorded at 423 K and 0.2 MPa.

FIG. 7. FFT patterns of the boxed, numbered regions of the lattice-resolution HRTEM image of a TAPPy-PDA COF crystal on the left, showing the predominant fringe spacing of ˜24 Å, d₁₀₀.

FIG. 8. FFT patterns of the boxed, numbered regions of the lattice-resolution HRTEM image of a TAPB-DMPDA COF crystal on the left, showing the predominant fringe spacing of ˜31 Å, d₁₀₀.

FIG. 9. Additional SEM and AFM images of TAPPy-PDA COF crystals of various sizes.

FIG. 10. Additional SEM and AFM images of TAPB-DMPDA COF crystals of various sizes.

FIG. 11. UV-Vis spectra of single-crystalline TAPPy-PDA COF crystals (colloidal suspension in acetonitrile) of various sizes.

FIG. 12. UV-Vis spectra of single-crystalline TAPB-DMPDA COF crystals (colloidal suspension in acetonitrile) of various sizes.

FIG. 13. ¹³C CP/MAS spectra of single-crystalline TAPPy-PDA COF powder.

FIG. 14. ¹³C CP/MAS spectra of single-crystalline TAPB-DMPDA COF powder.

FIG. 15. (A) PXRD and (B) N₂ uptake isotherm characterization of polycrystalline TAPPy-PDA COF. Inset in (A) shows SEM image and inset in (B) shows pore width distribution of the COF.

FIG. 16. (A) PXRD and (B) N₂ uptake isotherm characterization of polycrystalline TAPB-DMPDA COF. Inset in (A) shows SEM image and inset in (B) shows pore width distribution of the COF.

FIG. 17. FT-IR spectra of single- and polycrystalline TAPPy-PDA COFs, with imine (C═N) stretch appearing at ˜1620 cm⁻¹ as expected.

FIG. 18. FT-IR spectra of single- and polycrystalline TAPB-DMPDA COFs, with imine (C═N) stretch appearing at ˜1620 cm⁻¹ as expected.

FIG. 19. BET plots of single- and polycrystalline TAPPy-PDA COFs. P/P₀ ranges (0.05-0.2) determined based on linearity of slope.

FIG. 20. BET plot of single- and polycrystalline TAPB-DMPDA COFs. P/P₀ ranges (0.05-0.2) determined based on linearity of slope.

FIG. 21. SEM images depicting size control of TAPPy-PDA COF single crystals by modifying modulator (aniline) loading. All reactions were carried out using [TAPPy]=8 mM, at 90° C. for 5 minutes.

FIG. 22. SEM images of the largest crystals of TAPPy-PDA COF obtained at a reaction time of 48 h, aniline loading=1.6 equiv. per imine. Crystals in (A) obtained at 100° C. and [TAPPy]=8 mM. Crystals in (B) obtained at 110° C. and [TAPPy]=10 mM. Crystals in (C) obtained at 120° C. and [TAPPy]=12 mM.

FIG. 23. SEM images depicting size control of TAPB-DMPDA COF single crystals by modifying modulator (aniline) loading and monomer (TAPB) concentration. All reactions were carried out at 90° C. for 5 minutes.

FIG. 24. SEM images of the largest crystals of TAPB-DMPDA COF obtained at a reaction temperature of 150° C. and a reaction time of 48 h. Crystals in (A) obtained at aniline loading of 0.6 equiv. per imine and [TAPB]=12 mM. Crystals in (B) obtained at aniline loading of 0.7 equiv. per imine and [TAPB]=14 mM. Crystals in (C) obtained at aniline loading of 0.8 equiv. per imine and [TAPB]=16 mM.

FIG. 25. Crystal growth time for TAPB-DMPDA COF.

FIG. 26. Pawley refinements of (A) TAPPy-PDA and (B) TAPB-DMPDA COFs.

FIG. 27. Simulated fitting of largest sphere fitting in the pore of the simulated COF with an arrangement of 18 randomly stacked layers of (A) TAPPy-PDA and (B) TAPB-DMPDA COFs.

FIG. 28. (A) selectivity and (B) resolution for the gas chromatographic separation of a binary mixture of benzene and cyclohexane, on single-crystalline TAPPy-PDA COF-coated column, in the temperature range of 423-393 K. Data recorded at 0.2 MPa.

FIG. 29. Van't Hoff plots for benzene and cyclohexane, on single-crystalline TAPPy-PDA COF-coated column, in the temperature range of 423-393 K. Data recorded at 0.2 MPa.

FIG. 30. The plot of ln V_{g} versus 1/T for benzene and cyclohexane, on single-crystalline TAPPy-PDA COF-coated column, in the temperature range of 423-393 K. Data recorded at 0.2 MPa.

### DETAILED DESCRIPTION OF THE INVENTION

Two-dimensional (2D) covalent organic frameworks (COFs) are structurally precise, permanently porous, layered macromolecular sheets, which have traditionally been synthesized as polycrystalline solids with crystalline domain lengths smaller than 100 nm. Here we report a new method to polymerize COFs as suspensions of faceted single crystals rather than polycrystalline powders. These improved conditions enable high-quality COF synthesis in as little as a few minutes at moderate temperature and ambient pressure.

The Examples demonstrate single-crystalline COFs of imine-linked 2D structures have been prepared. The Examples show preparation of a square-lattice 2D COF (e.g., TAPPy-PDA) and a hexagonal-lattice 2D COF (e.g., TAPB-DMPDA). The sizes of TAPPy-PDA and TAPB-DMPDA COF crystals were tuned from 720 nm to 1.3 μm and 450 nm to 20 μm in width, respectively. The COF crystals consist of layered, 2D polymers comprised of single-crystalline domains, as corroborated by high-resolution transmission electron microscopy (HRTEM). Continuous rotation electron diffraction characterization (cRED) was used to resolve the unit cell and crystal structure of both COFs, which suggested that the materials are single-crystalline in the a-b planar dimensions but disordered in the stacking c dimension. TAPPy-PDA COF single crystals were incorporated into a gas chromatography (GC) separation column and exhibited excellent separation of benzene and cyclohexane along with an unusual selective retention of cyclohexane over benzene. Polycrystalline samples of the same COF exhibited no benzene/cyclohexane separation, indicating the importance of improved materials quality for COFs to exhibit properties that derive from their precise crystalline structures. This approach represents the first example of synthetically obtaining 2D COF single crystals under operationally simple conditions and short reaction times.

To address this need to improve the materials quality of polycrystalline COFs, growing COF particles as colloidal suspensions is a means of preventing uncontrolled aggregation and precipitation, a prerequisite to controlling the nucleation and polymerization processes that underlie 2DP materials quality. 2D COFs formed using Schiff base chemistries, especially imine linkages, have since emerged as the most common and versatile class of 2DPs because of the broad scope of available monomers, and the good to excellent chemical and thermal stabilities of the resultant 2DPs. Imine-linked COFs may also be transformed to even more stable amide, β-ketoenamine, or thiazole structures, such that achieving improved control of imine-linked 2D COFs might indirectly provide access to many other high-quality 2DPs. Early mechanistic studies of imine-based 2D polymerizations suggested that the rapid formation of a polymer network followed by crystallization by imine exchange reactions occurred under most solvothermal conditions.

Two-dimensional covalent organic frameworks (2D COFs) are a class of modular, molecularly precise, highly porous, layered polymer sheets. These attributes impart a unique combination of physical properties compared to conventional polymers, such as high thermomechanical stabilities and low densities. Challenges associated with characterizing conventionally isolated polycrystalline COF powders have restricted the exploration of many 2D COF properties.

As used herein, a “covalent organic framework” or “COF” is a two- or three-dimensional organic solid with extended, periodic, and porous structures in which a plurality of linking groups (LGs) and functional building units (FBUs) are linked by covalent bonds. Suitably, COFs may be made entirely from light elements (e.g., H, B, C, N, and O). Two-dimensional COFs can self-assemble into larger structures. In some embodiments, layered 2D COF sheets adopt nearly eclipsed stacked structures, providing continuous nanometer-scale channels normal to the stacking direction, as well as significant π-orbital overlap between monomers in adjacent layers. These features can provide an accessible high surface area interface.

COFs are crystalline. For example, the COFs can form platelets. The COF “platelet” is a particle that is many layered, substantially single-crystalline 2D polymer sheets and the sheets are stacked with some amount of disorder. COF platelets have lateral dimensions of at least 400 nm. The COF platelet comprises a multiplicity of crystals of an imine-linked 2D-COF oriented with inter-sheet stacking in a direction out-of-plane with the lateral dimensions and wherein each of the multiplicity of crystals of imine-linked 2D-COF comprise a substantially single-crystalline domain. As used herein, a substantially single-crystalline domain refers to COF having characteristics of a single crystal of the COF. The single crystal characteristics may be determined by methods known in the art such as TEM (e.g., HRTEM), FFT patterns, or continuous rotations elections diffraction.

In some embodiments, the COF platelets have lateral dimensions of at least 600 nm, 800 nm, 1.0 μm, 1.5 μm, 2.0 μm, 2.5 μm, 3.0 μm, 3.5 μm, 4.0 μm, 4.5 μm, 5.0 μm, 5.5 μm, 6.0 μm, 6.5 μm, 7.0 μm, 7.5 μm, 8.0 μm, 8.5 μm, 9.0 μm, 10.0 μm, 11.0 μm, 12.0 μm, 13.0 μm, 14.0 μm, 15.0 μm, 16.0 μm, 17.0 μm, 18.0 μm, 19.0 μm, 20.0 μm, 40 μm, 60 μm, 80 μm, 100 μm, 200 μm, 300 μm, 400 μm, 500 μm, 600 μm, 700 μm, 800 μm, 900 μm, 1000 μm, 5000 μm, or 10000 μm. In some embodiments, the COF platelets have lateral dimensions between 400 nm and 20.0 μm, including all values and ranges therebetween. For example, the COF platelets may have lateral dimensions between about 400 nm-7.0 μm, 700 nm-1.3 μm, 2.0-4.0 μm, 10.0 μm and 20.0 μm.

COF platelets have a thickness in a direction out-of-plane with the lateral dimensions smaller than the lateral dimension of the platelet. The COF platelets may have a thickness of 10 nm to 5 microns, including all values and ranges therebetween. In some embodiments, the COF thin film has a thickness of 20 nm to 4.0 μm, 30 nm to 3.0 μm, 40 nm to 2.0 μm, 50 nm to 1.5 μm, including all values and ranges therebetween.

COF are porous materials. In some embodiments, COFs are microporous, i.e., have pores with a longest dimension of less than 2 nm, or mesoporous, i.e., have pores with a longest dimension of 2 nm to 50 nm. The porous structure may form a repeating pattern rather than a random distribution of pores.

COFs can have high surface areas. COFs can have surface areas ranging from 500 m²/g to 4000 m²/g, including all values to the m²/g and ranges of surface area therebetween. The surface area of the COFs can be determined by methods known in the art, for example, by BET analysis of gas (e.g., nitrogen) adsorption isotherms.

A “building unit” or “BU” comprises a molecular subunit having two or more functional termini that can be covalently bonded to an equal number of different linker groups (LGs). The covalent linkages between the BUs and LGs provide robust materials with precise and predictable control over composition, topology, and porosity. The relative geometries of the functional termini in the starting materials determine the COF topology.

A “linking group” or “LG” comprises a molecular subunit having two or more functional termini that can be covalently bonded to an equal number of BUs. In some embodiments, at least three BUs are each connected to a LG by covalent bond(s) or at least three LGs are each connected to a BU by covalent bond(s). For example, a BU and a LG may be connected by at least one covalent bond. In other examples, the BUs and LGs are connected by one covalent bond, two covalent bonds, or three covalent bonds. The BUs and LGs can be connected by carbon-nitrogen bonds (e.g., an imine bond).

BUs and LGs may be selected to prepare a COF having a desired geometry, crystalline structure, chemical functionality, and/or porosity. Exemplary BUs and LGs may be selected to allow for the formation of COFs having 2-D arrangements. BUs and LGs suitable for formation of 2D COFs include, without limitation, BUs and LGs having linear, trigonal planar, square planar, or hexagonal planar geometries. Suitably, the COFs may comprise BUs or LGs having trigonal planar geometries such as 1,3,6,8-tetrakis(4-aminophenyl)pyrene (TAPPy), 1,3,5-tris(4-aminophenyl)benzene (TAPD), terephthalaldehyde (PDA), or 2,5-dimethoxyterephthalaldehyde (BMPDA).

In some embodiments, the BU and/or LG is comprised of an aryl moiety but BUs or LGs without an aryl moiety may also be used. The term “aryl” is art-recognized and refers to a carbocyclic aromatic group or heterocyclic aromatic groups. Representative aryl groups include phenyl, naphthyl, anthracenyl, pyrenyl, pyridine, furan, thiophene, and the like. The term “aryl” includes polycyclic ring systems having two or more carbocyclic rings in which two or more carbons are common to two adjoining rings (the rings are “fused rings”) wherein at least one of the rings is aromatic and, e.g., the other ring(s) may be a cycloalkyl, cycloalkenyl, cycloalkynyl, and/or aryls. The term “aryl” includes polycyclic ring systems having two or more carbocyclic rings in which one carbon is common to a directly-adjoining ring (e.g., a biphenyl) or an indirectly adjoining ring, where the indirectly a joining rings are linked by a linker comprising one or more atoms (e.g., diphenylbutadiyne), wherein at least one of the rings is aromatic and, e.g., the other ring(s) may be a cycloalkyl, cycloalkenyl, cycloalkynyl, and/or aryls. Unless specified otherwise, the aromatic ring may be substituted at one or more ring positions with, for example, halogen, azide, alkyl, aralkyl, alkenyl, alkynyl, cycloalkyl, hydroxyl, alkoxyl, amino, nitro, sulfhydryl, imino, amido, carboxylic acid, —C(O)alkyl, —CO₂ alkyl, carbonyl, carboxyl, alkylthio, sulfonyl, sulfonamido, sulfonamide, ketone, aldehyde, ester, heterocyclyl, aryl or heteroaryl moieties, or the like. In certain other embodiments, the aromatic ring is not substituted, i.e., it is unsubstituted.

In some embodiments, the BU comprises two or more aldehyde moieties. When the BU comprises aldehyde moieties and the LG comprises amine moieties. Exemplary BUs include, without limitation, terephthalaldehyde (PDA) or 2,5-dimethoxyterephthalaldehyde (BMPDA). Exemplary BUs include, without limitation, 1,3,6,8-tetrakis(4-aminophenyl)pyrene (TAPPy) or 1,3,5-tris(4-aminophenyl)benzene (TAPD).

COF platelets may be prepared by contacting a building unit and linking group in a nitrile-containing solvent in the presence of a modulator of polymerization and catalyst for defect correction (which may be referred to as a modulator). The modulator may comprise an amine group or an aldehyde group. For an example, the modulator may be aniline or a substituted aniline. Substituted anilines include anilines having one or more non-hydrogen substituents on the ring structure. For another example, the modulator may be benzaldehyde or a substituted benzaldehyde. Substituted benzaldehyde include benzaldehydes having one or more non-hydrogen substituents on the ring structure. The nitrile-containing solvent comprises a nitrile group. For an example, the nitrile-containing solvent may be benzonitrile or acetonitrile. The nitrile-containing solvent may further comprise one or more additional components, such as benzoic acid.

The linking and building units may be contacted at a reaction temperature from about 90-150° C. For example, the linking and building units may be contacted at a reaction temperature of about 90° C., 95° C., 100° C., 105° C., 110° C., 115° C., 120° C., 125° C., 130° C., 135° C., 140° C., 145° C., or 150° C.

The reaction may be completed within 1 day. In some examples, the reaction is completed within 6 hours, 2 hours, 1 hours, 30 minutes, 15 minutes, 10 minutes, or 5 minutes.

The modulator may be present in an amount of about 0.2 to 2.0 equivalents of the modulator to aldehyde functional group of the building or linking unit. In some embodiments, the modulator is present in an amount of about 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, including any range therebetween.

The COF platelets described herein may be used to prepare components, such as a column, or gas chromatographs for separating a mixture. Columns for separation may be prepared by incorporating the COF platelets described herein within the column. For example, a solution comprising the COF platelets may coat the column. The column comprising the COF platelets may be integrated into a gas chromatograph and used to connects a sample inlet configured to receive a sample and a detector configured to detect retention times of different components of a sample. Suitably, the COF platelets described herein may be characterized by preferential adsorption of cyclohexane over benzene. Notably, polycrystalline materials composed of the same COF may fail to demonstrate preferential adsorption of cyclohexane over benzene.

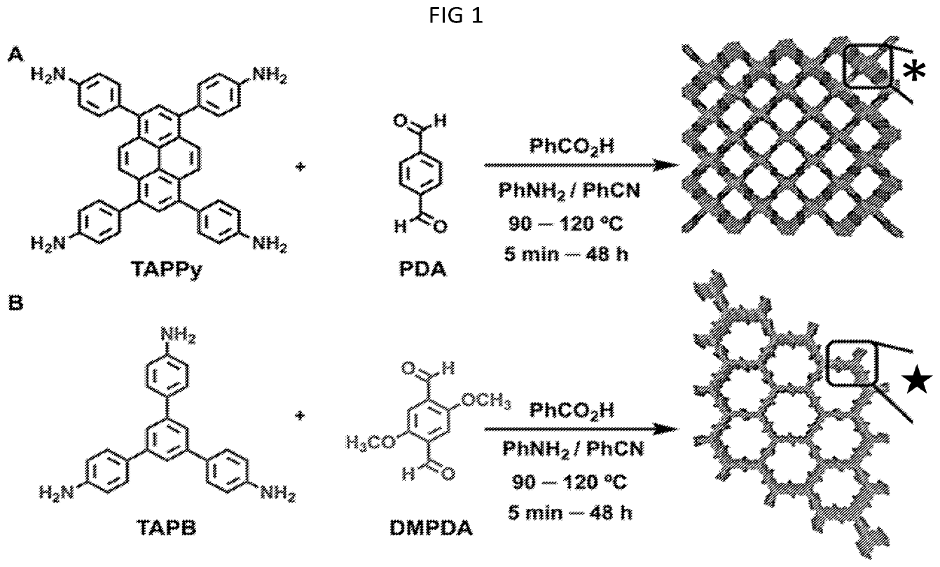

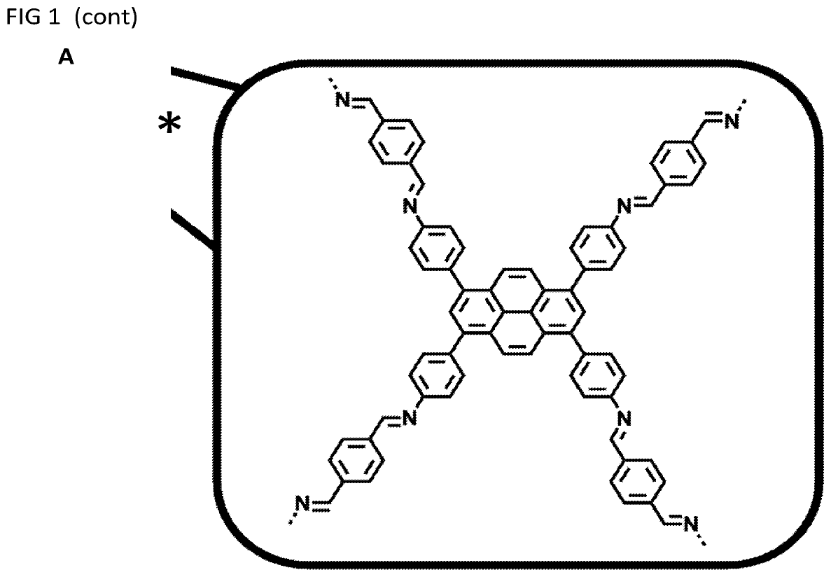

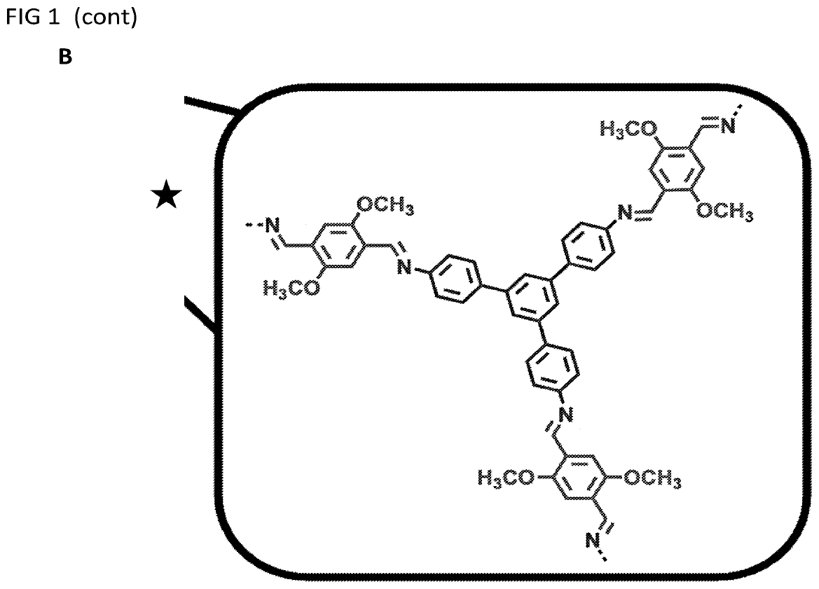

Imine-linked 2D COF solvothermal polymerization conditions provide TAPPy-PDA COF (FIG. 1) as micron-sized single crystals in as little as five minutes. These conditions use a nitrile-containing solvent, aniline as a monofunctional modulator of the polymerization and catalyst for defect correction, and elevated reaction temperature, as parameters that influence the crystallite size. Similar conditions also provided TAPB-DMPDA COF as the first hexagonal imine-linked 2D COF to be isolated in this single-crystalline form. The COFs exhibit excellent crystallinity and porosity, as determined by powder X-ray diffraction (PXRD) patterns and N₂ adsorption isotherms. High-resolution transmission electron microscopy (HRTEM) analysis confirms that the polymer sheets are single-crystalline domains, and continuous rotation electron diffraction (cRED) reveals that these structures are single-crystalline in the plane of covalent bonding, yet disordered in the stacking direction, as there are multiple ways that the sheets can be offset with respect to one another. This approach is a readily available and rapid method to prepare high-quality imine-linked COFs that might enable the practical synthesis of other imine-linked 2DPs.

Finally, we demonstrate that the TAPPy-PDA COF single crystals effectively separate benzene and cyclohexane when used as a stationary phase in gas chromatography, whereas polycrystalline samples of the same material show no separation. This separation is an important industrial process that is conventionally difficult by distillation because their boiling points differ by only 0.6° C., among other similar physical properties. Here we show that the TAPPy-PDA 2D COF crystals show a fast, high-resolution, and efficient gas chromatographic separation of benzene and cyclohexane in as little as 30 seconds, also with a reversed selectivity for cyclohexane adsorption. Meanwhile, the polycrystalline samples of the TAPPy-PDA COF show no separation and shorter retention times for both analytes when tested under the same conditions. We used an inverse gas chromatography (IGC) approach to characterize the physicochemical motivations of separation over TAPPy-PDA COF as the first COF to show this reversed selectivity of cyclohexane over benzene. These findings are of great promise for difficult molecular separations and highlight that high-quality 2D COF samples can exhibit distinct and useful properties relative to polycrystalline samples with the same chemical composition.

### Synthesis and Characterization of COF Single Crystals

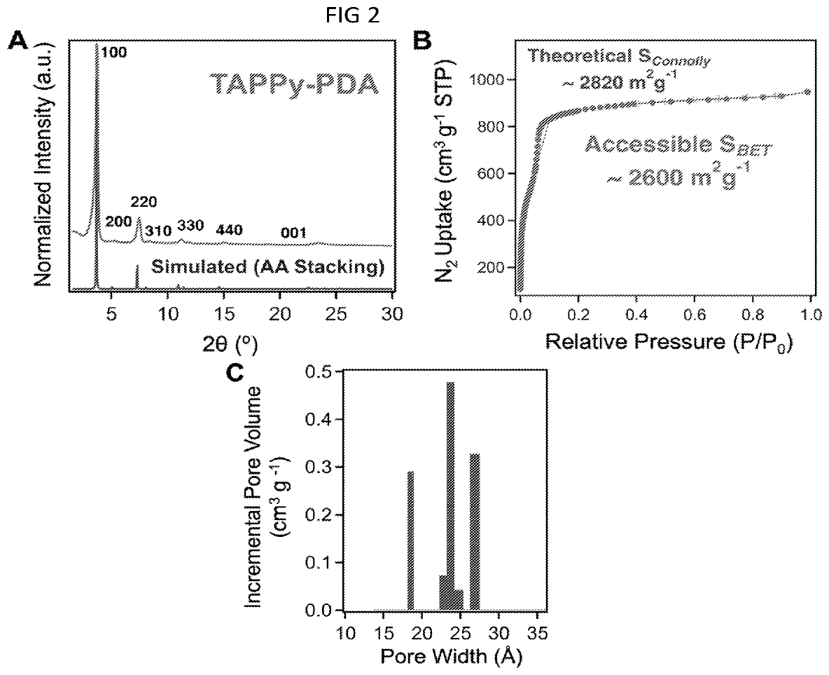

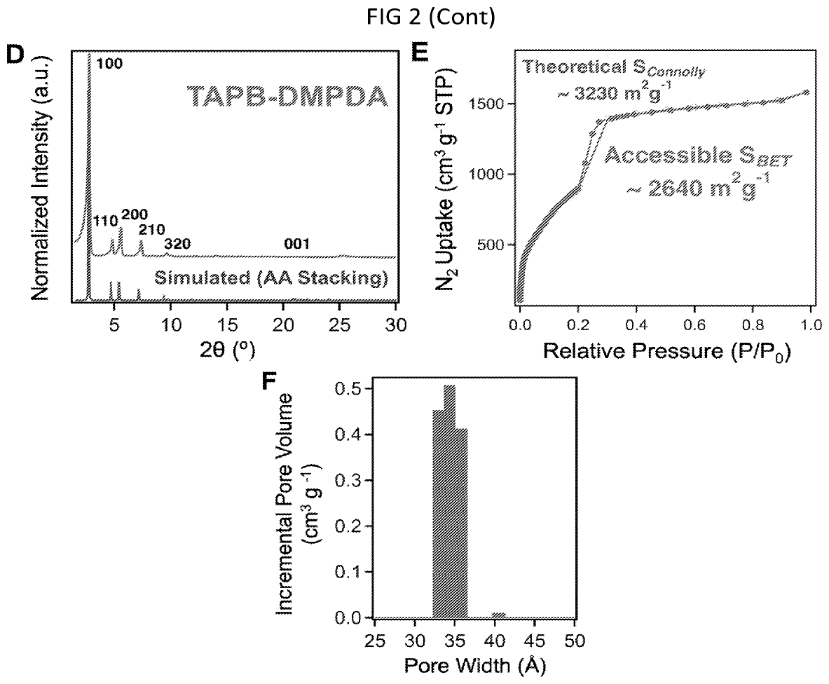

The imine-linked 2D COF derived from 1,3,6,8-tetrakis(4-aminophenyl)pyrene (TAPPy) was synthesized at 90° C. by condensing TAPPy and terephthalaldehyde (PDA) in the presence of benzoic acid and aniline in benzonitrile (FIG. 1A). The hexagonal TAPB-DMPDA COF network was synthesized by condensing 1,3,5-tris(4-aminophenyl)benzene (TAPB) and 2,5-dimethoxyterephthalaldehyde (DMPDA) under similar conditions (FIG. 1B). For both polymerizations, brightly colored colloidal suspensions (orange for TAPPy-PDA; red for TAPB-DMPDA) formed within minutes. Scanning electron microscopy (SEM) and high-resolution transmission electron microscopy (HRTEM) images of the drop-cast colloidal COF solutions showed 1 μm-wide square platelets and 1 μm-wide hexagonal platelets for the TAPPy-PDA and TAPB-DMPDA COFs, respectively. These faceted particles exhibit the same shapes as the layered square and hexagonal lattices of each COF. The colloids were precipitated from solution by adding saturated aqueous NaCl and methanol, filtered, washed by Soxhlet extraction using methanol, and activated using a supercritical CO₂ dryer. The resulting solids were highly crystalline and porous, as confirmed by PXRD patterns (FIGS. 2A and D) and N₂ uptake isotherms of the isolated colloids (FIGS. 2B and E). The PXRD patterns of the TAPPy-PDA and TAPB-DMPDA COFs exhibited sharp (100) Bragg diffraction peaks at 26=2.78° and 3.68°, respectively, as well as the corresponding higher order Bragg diffraction peaks, consistent with previously reported powder patterns and average eclipsed (AA) models of the COFs, except for broadening of the (001) peaks (FIGS. 2A and D). Analysis of the N₂ uptake isotherms of both COFs provided Brunauer-Emmett-Teller (BET) surface areas of 2600 m² g⁻¹ for the TAPPy-PDA COF and 2640 m² g⁻¹ for the TAPB-DMPDA COF (FIGS. 2B and E), from which non-localized density functional theory (NLDFT) analysis provided narrow pore width distributions centered at 2.3 nm and 3.4 nm for the TAPPy-PDA and TAPB-DMPDA COFs, respectively (FIGS. 2C and F). Additionally, these experimentally measured BET surface areas were within 20% of their Connolly surface areas, indicating that the isolated and activated samples exhibit the permanent porosity as expected for a high-quality COF sample. Collectively, these bulk characterization techniques indicate that the polymerizations of the TAPPy-PDA and TAPB-DMPDA COFs under the conditions reported above provide highly crystalline and porous samples.

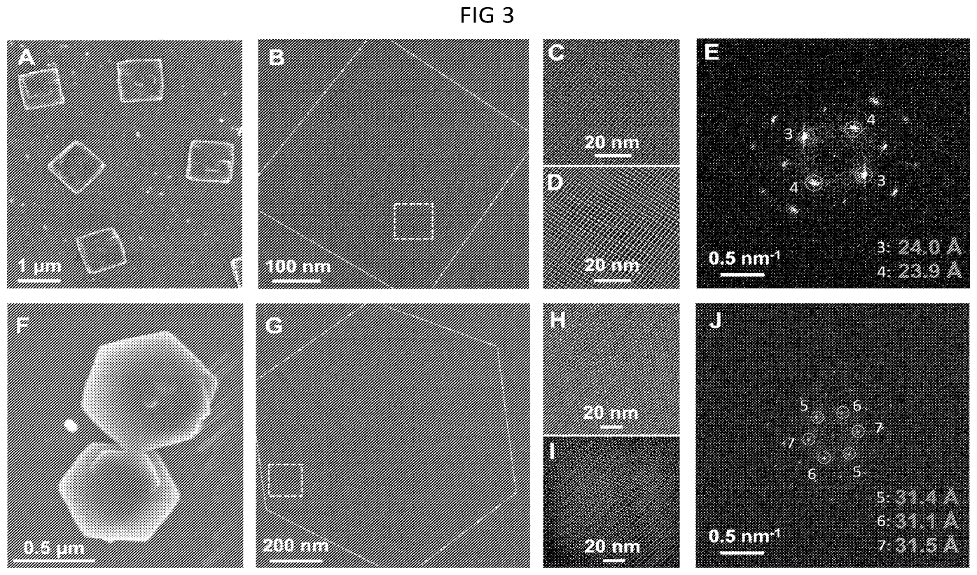

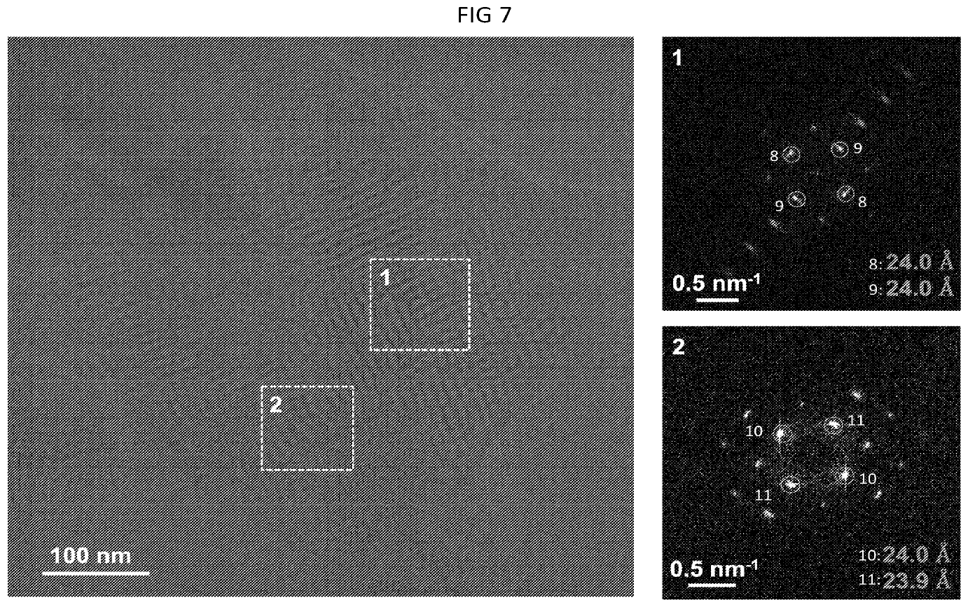

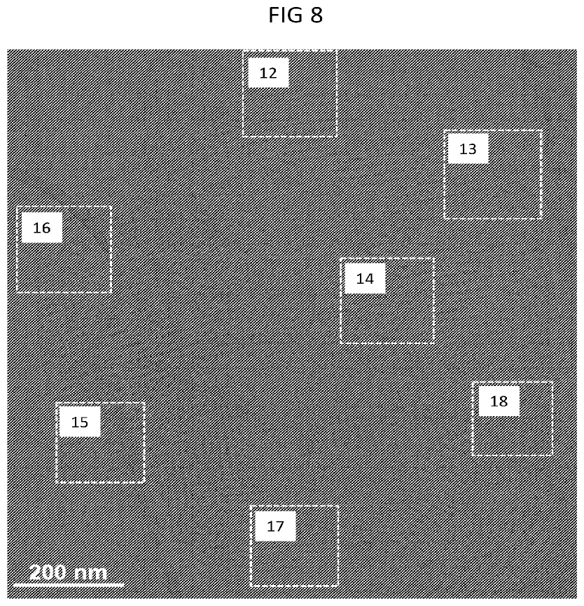

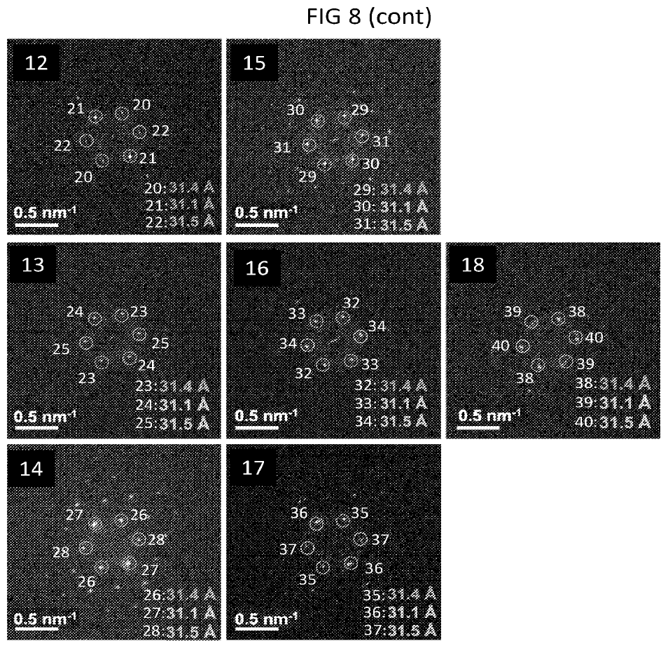

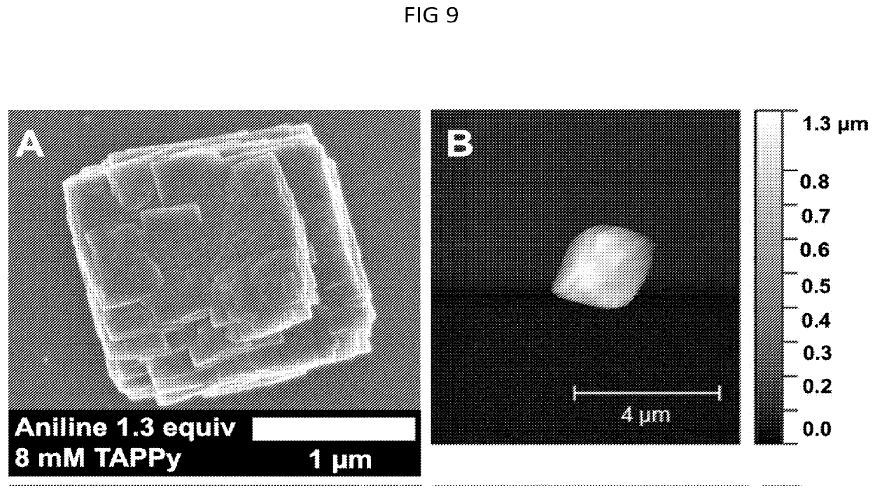

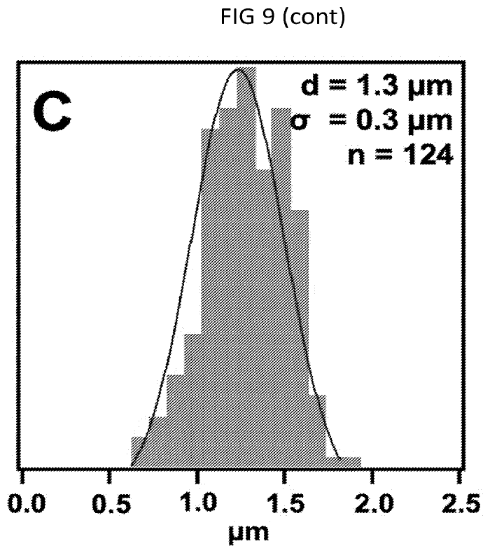

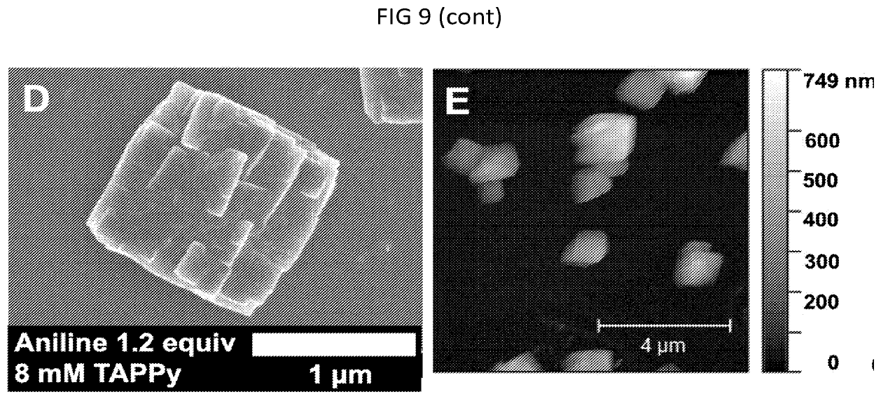

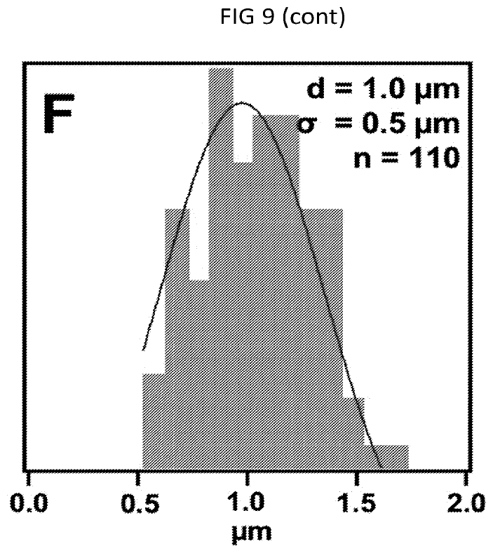

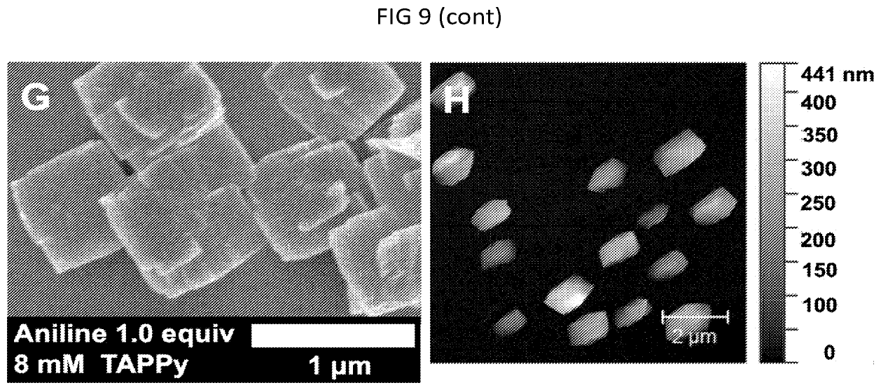

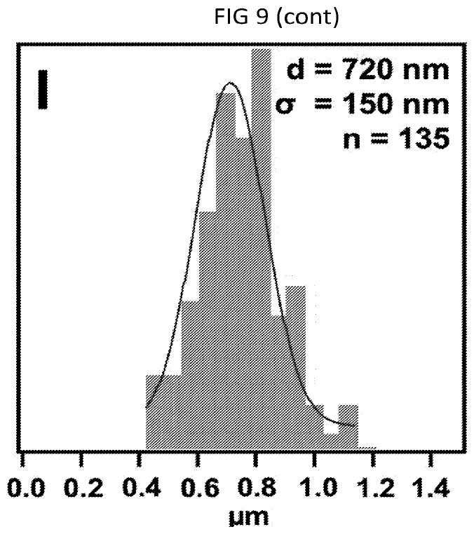

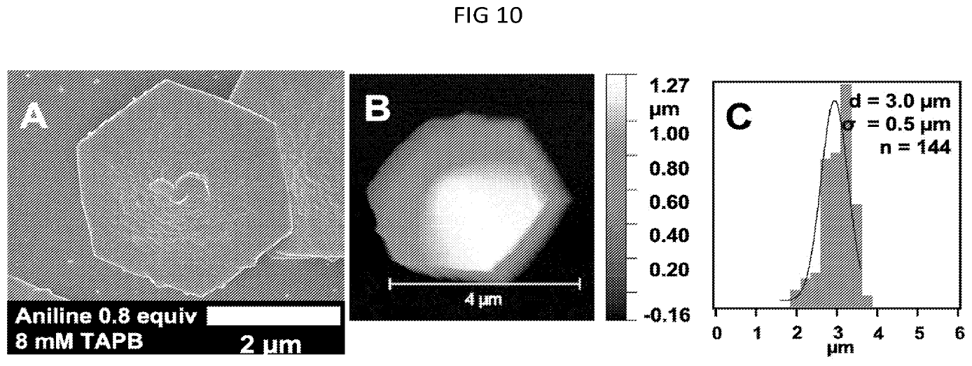

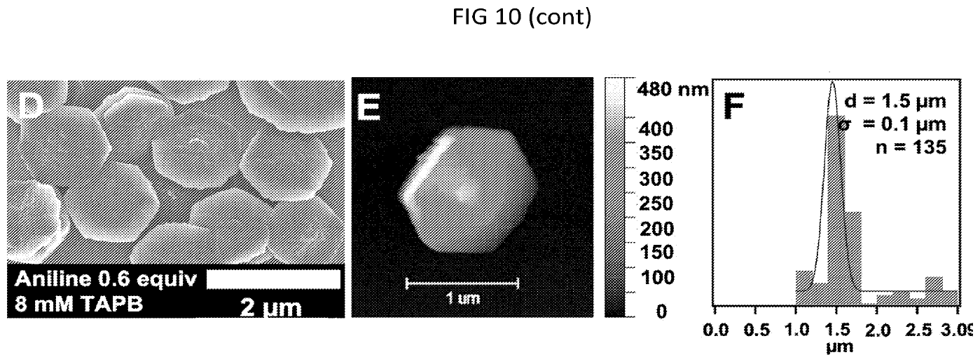

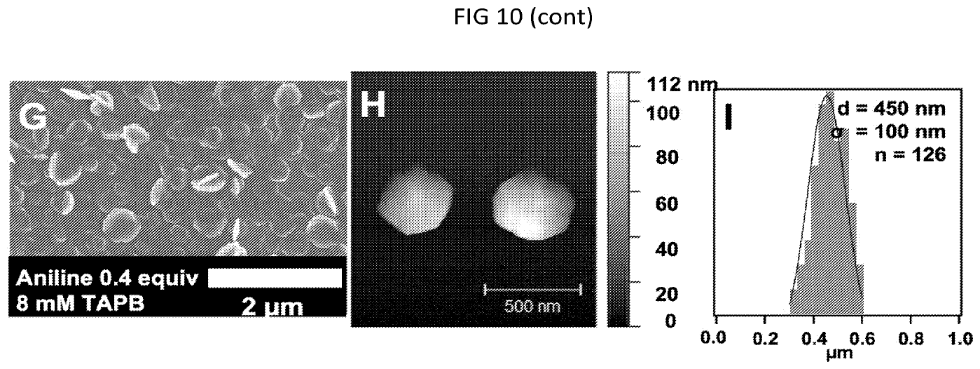

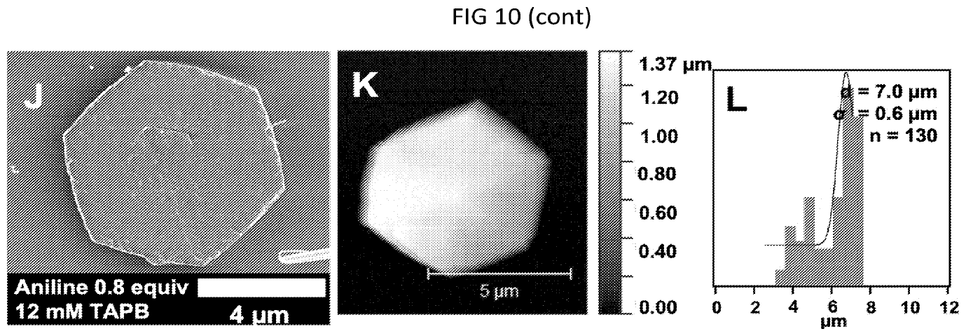

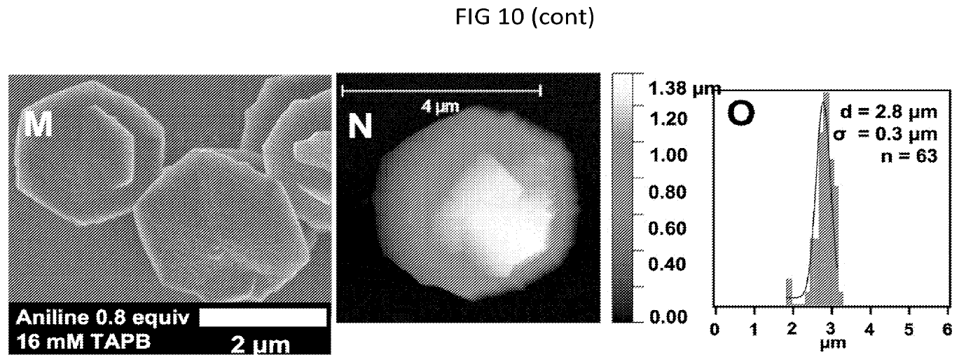

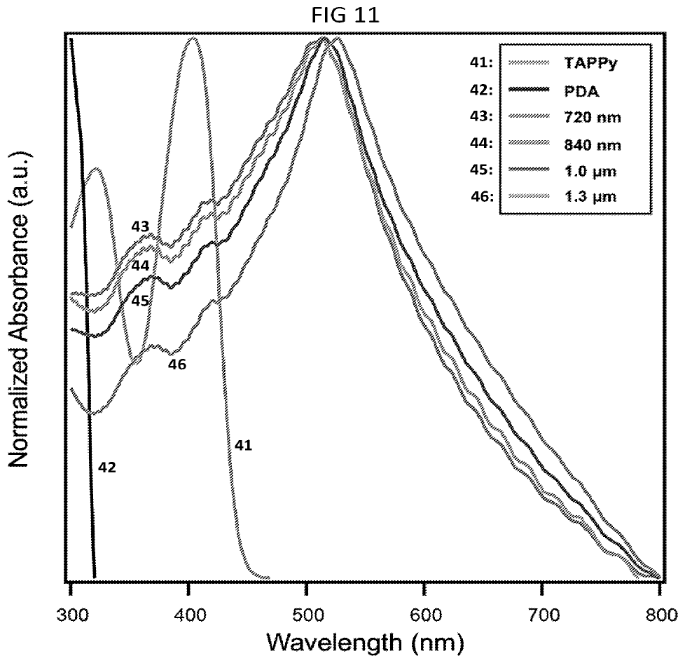

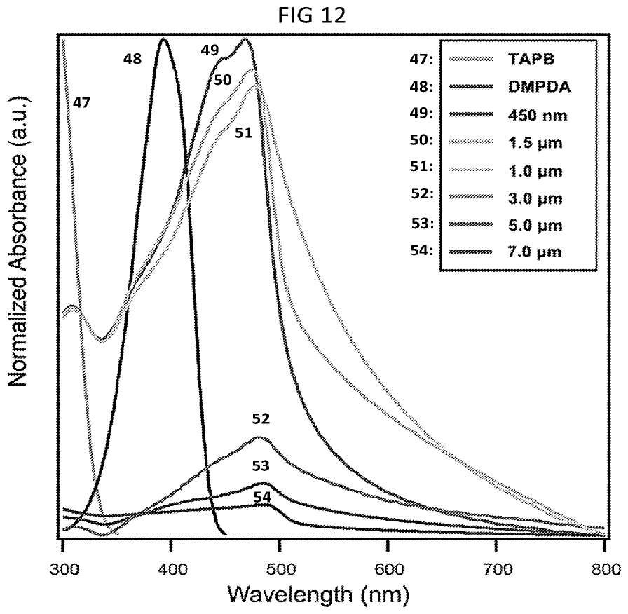

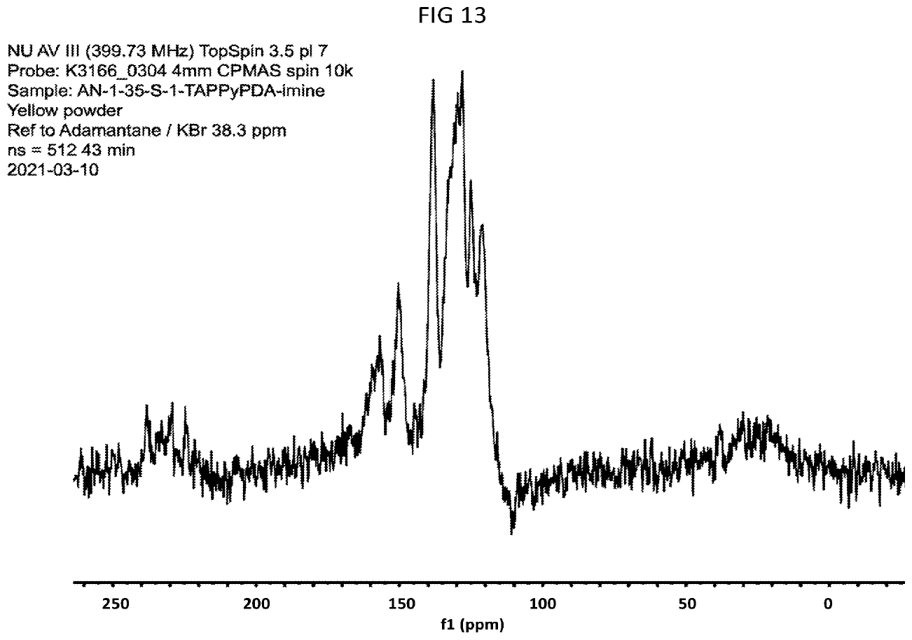

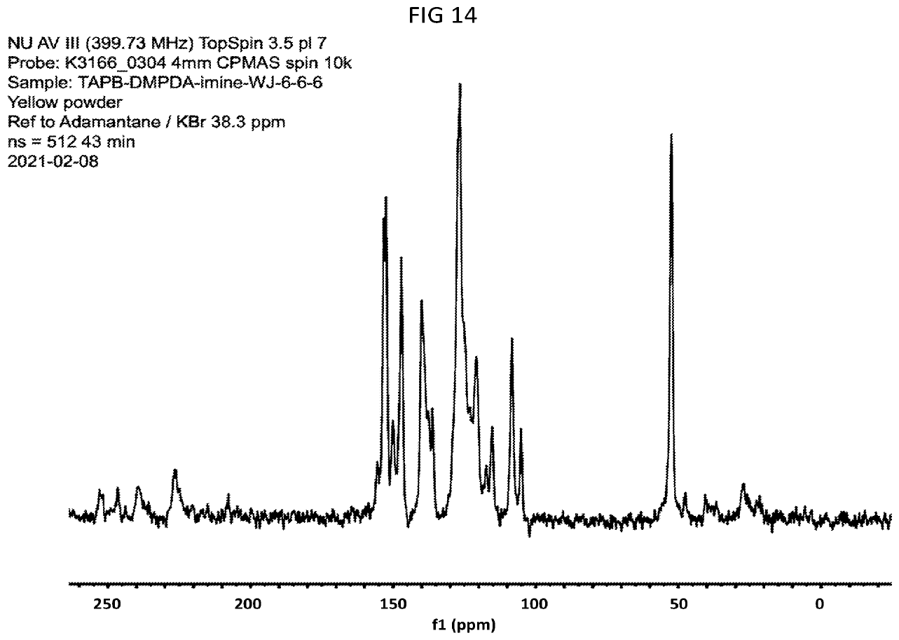

The 1 μm-sized square TAPPy-PDA COF platelets and hexagonal TAPB-DMPDA COF platelets showed characteristics attributed to COF single crystals, as determined by low-dose HRTEM (FIG. 3B-E; 3G-J). TEM imaging at low magnification confirmed that the TAPPy-PDA COF platelets had uniform four-fold symmetry and were faceted squares, consistent with their visualization by SEM (FIG. 3A) and atomic force microscopy (AFM) (FIG. 9), while the hexagonally faceted platelets of TAPB-DMPDA COF exhibited uniform six-fold symmetry, which was also consistent with these imaging techniques (FIG. 3F and FIG. 10). The COF crystals were preferentially oriented with their inter-sheet stacking dimension normal to the TEM substrate, which is likely due to their z-dimension (particle thickness) being smaller than their lateral dimensions (FIGS. 3B and G). Furthermore, lattice-resolution TEM images of individual COF particles suggested that they are single-crystalline (FIG. 3B-E) with consistent and continuous lattice fringes that extended throughout the particles. For the TAPPy-PDA COF particle shown in FIG. 3B, the lattice spacings were 23.9 and 24.0 Å, as measured by fast Fourier transform (FFT; FIG. 3E), which match the expected d₁₀₀ spacing. For the TAPB-DMPDA COF (FIG. 3H), the d₁₀₀ spacings were 31.1, 31.4, and 31.5 Å, as measured by FFT (FIG. 3J). Additional images and FFT patterns of other regions of these COF particles (FIGS. 7 and 8) also exhibited identical d₁₀₀ features at 24.0 Å (for TAPPy-PDA) and 31.5 Å (for TAPB-DMPDA). Taken together, the HRTEM images and the FFT patterns of the TAPPy-PDA and TAPB-DMPDA COF crystals are consistent with the formation of layered 2D polymers in which each sheet is comprised of a single-crystalline domain.

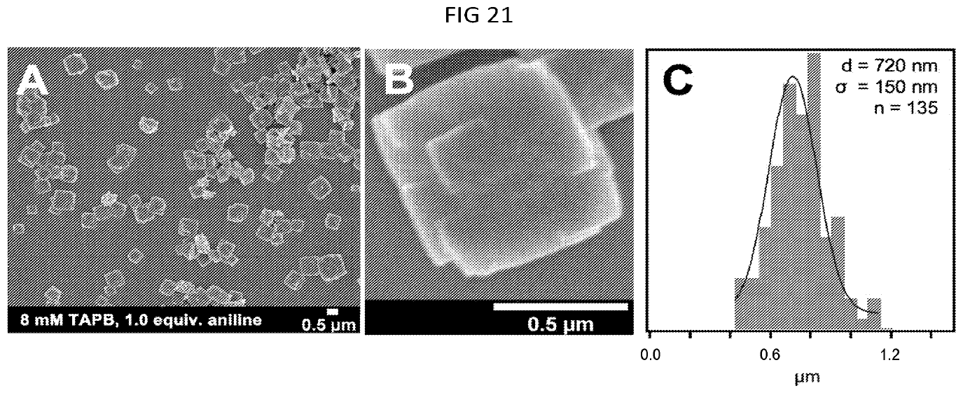

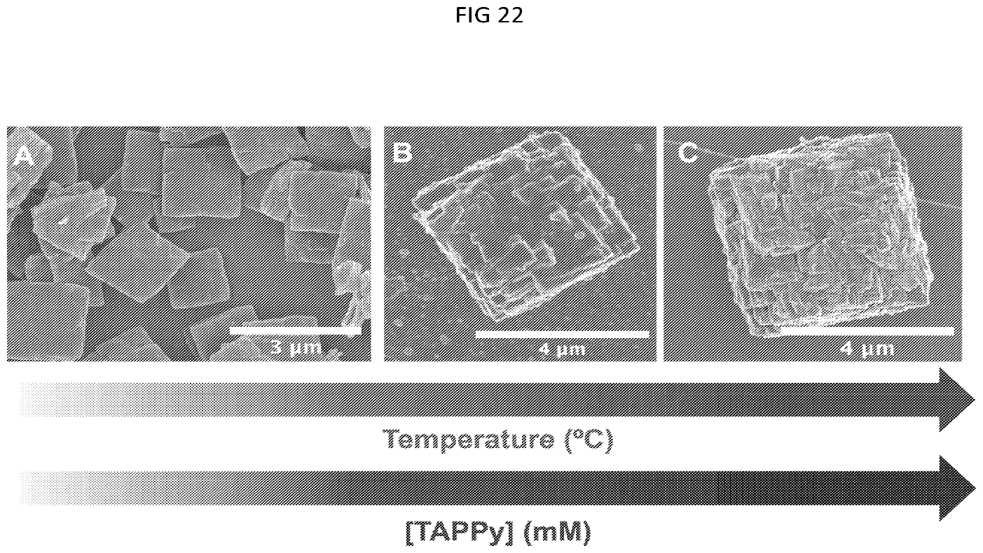

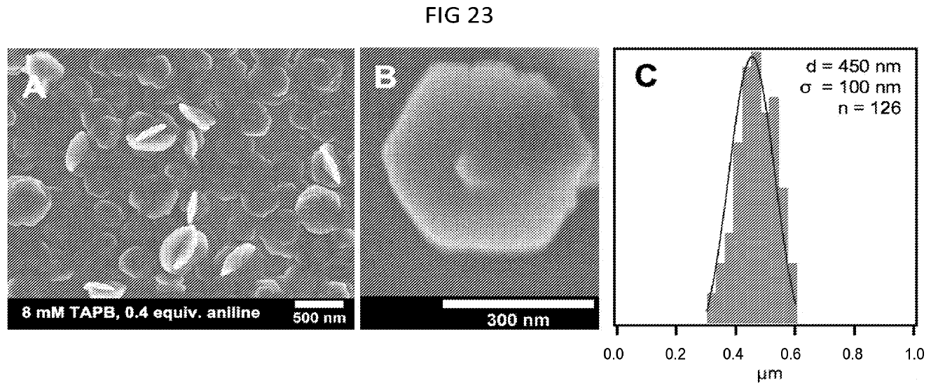

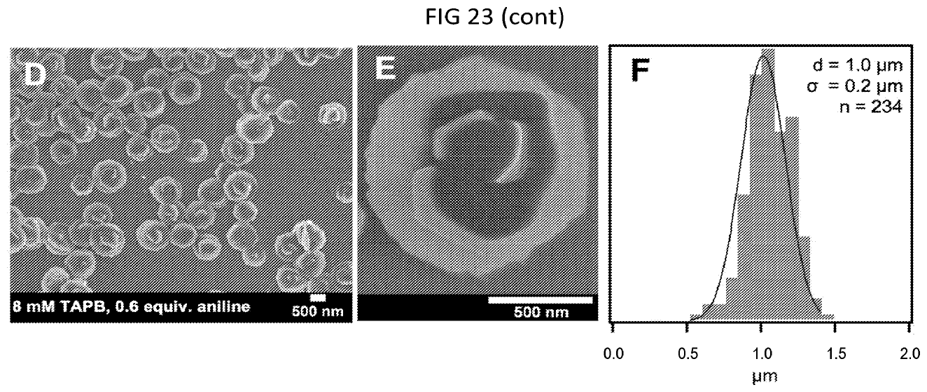

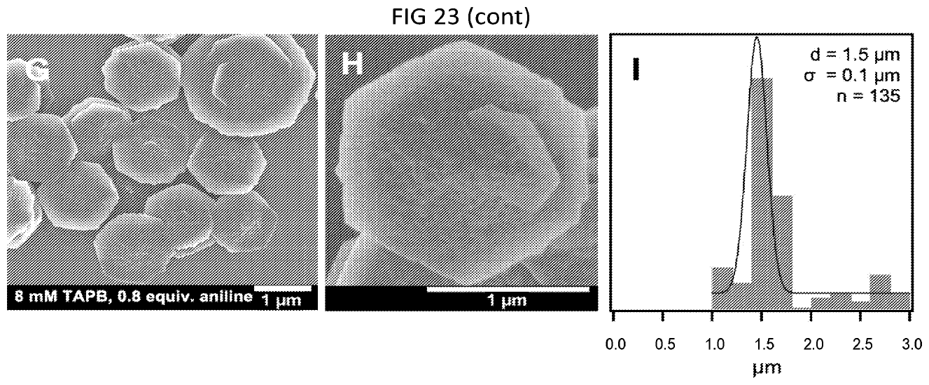

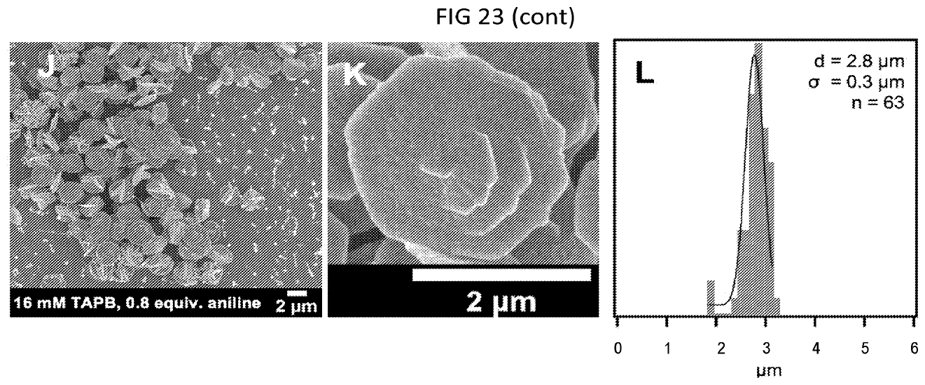

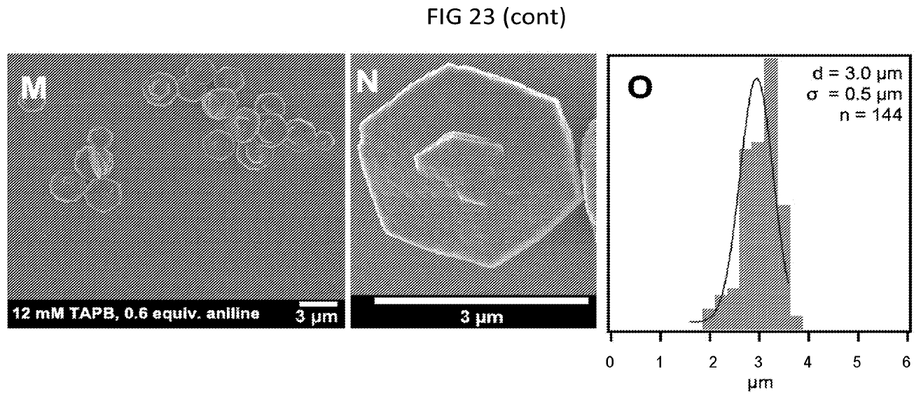

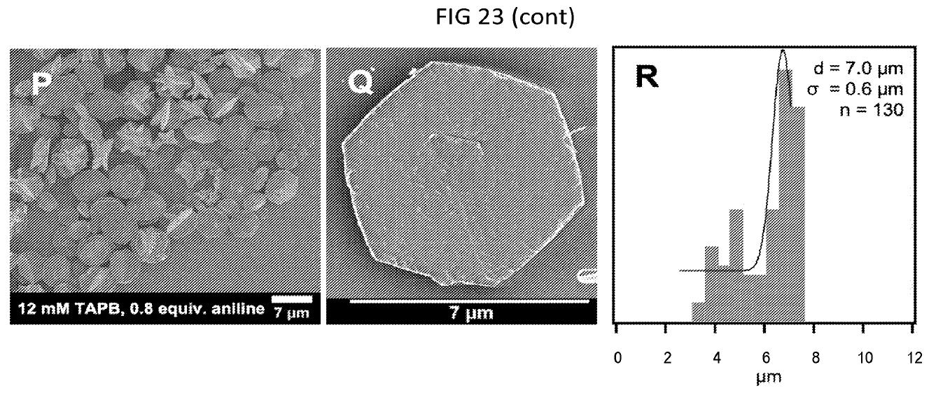

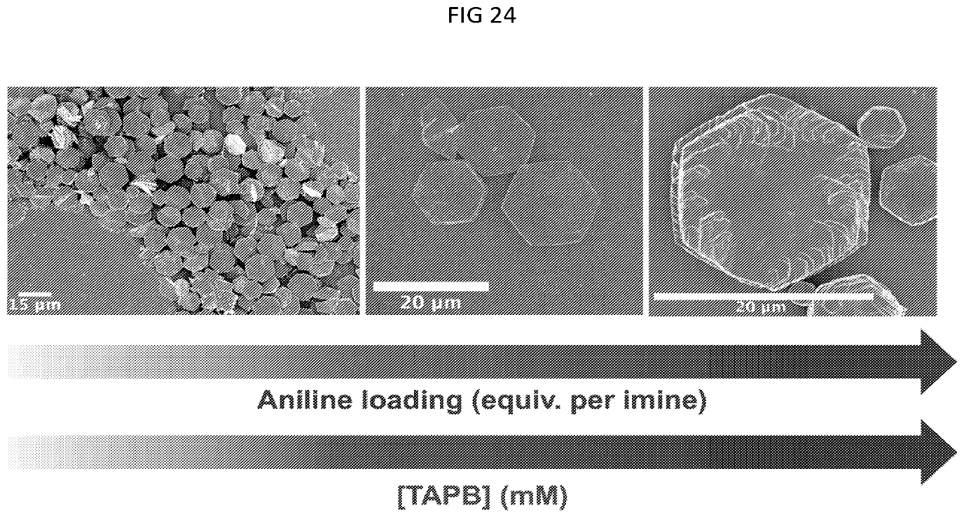

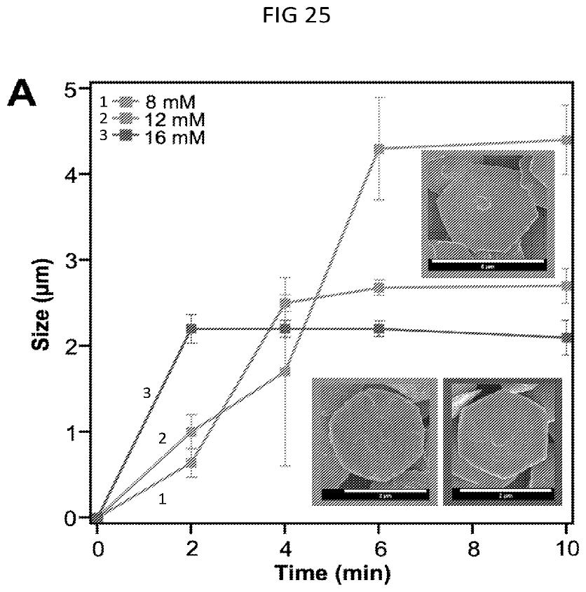

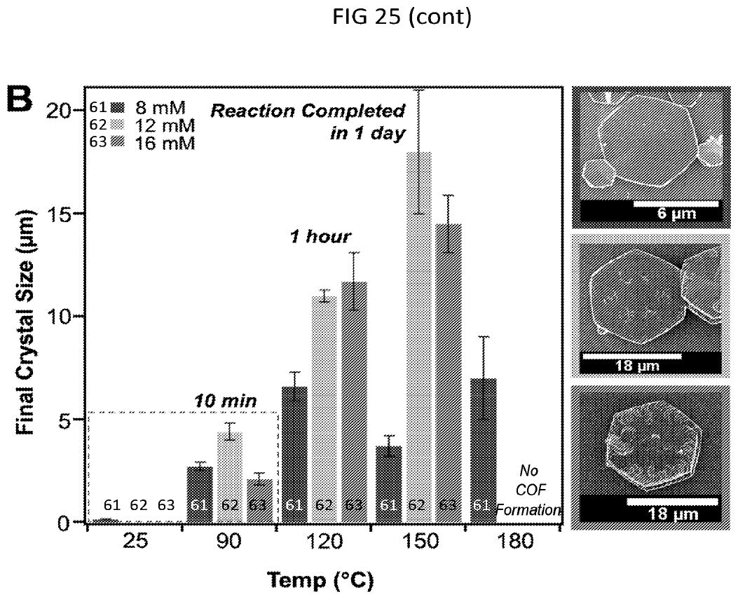

Larger crystals of each COF were prepared by varying their crystallization conditions to provide 4 μm-wide squares of TAPPy-PDA and 20 μm-sized hexagons of TAPB-DMPDA COF by optimizing the monomer concentration, aniline loadings, and reaction temperature (FIG. 21-25). Varying the monomer concentration between 8 and 16 mM and varying the aniline loadings between 1.0 and 1.6 equiv. at the initial reaction temperature of 90° C. resulted in a broad range of final TAPPy-PDA COF crystal sizes, from 720 nm to 4 μm in diameter and up to 1 μm in thickness (FIG. 21). TAPB-DMPDA COF crystal sizes varied from 450 nm to 7.0 μm in diameter and 100 nm to 1.4 μm in thickness when the monomer concentration was increased from 8 to 16 mM and aniline loadings were increased from 0.4 to 0.8 equiv. (FIG. 23). Based on SEM images of drop-cast aliquots of the TAPB-DMPDA COF polymerizations isolated at different reaction times, the crystals reached their final sizes within 6 minutes, after which they did not increase in size (FIG. 25A). We hypothesized that increasing the reaction temperature would slow nucleation based on our recent study of COF recrystallization and the temperature-dependence of the imine/aldehyde equilibrium. Indeed, a polymerization temperature of 150° C. produced TAPB-DMPDA COF crystals of up to 20 μm in size. Notably, despite the higher reaction temperature, these conditions required reaction times of 48 h to reach their final sizes. This observation is consistent with the increased crystal size deriving from imine formation being less favorable at elevated temperatures. Similarly, polymerization at 120° C. provided slightly larger TAPPy-PDA COF crystals with 4 μm lateral dimensions after 48 h. However, further temperature increases did not provide larger TAPPy-PDA COF crystals, presumably because the nucleation of COF particles was not significantly attenuated over this temperature range. In general, the combination of larger crystals and longer reaction times at elevated temperatures suggests that the reduced driving force for imine formation influences the COF nucleation and growth processes. These results demonstrate that reaction parameters such as monomer concentration, aniline concentration, and temperature impact the nucleation and growth processes of imine-linked 2D COFs, and suggest further opportunities for monomer design or other additives that might be explored to further control these 2D polymerizations.

### Structure Determination by Continuous Rotation Electron Diffraction

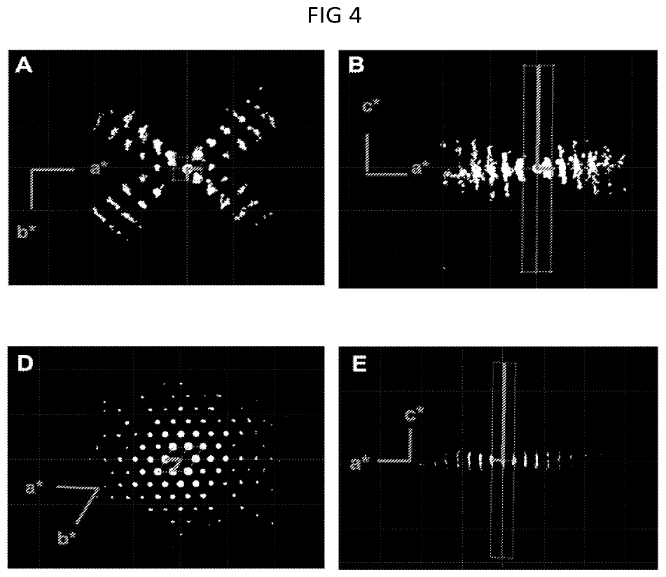

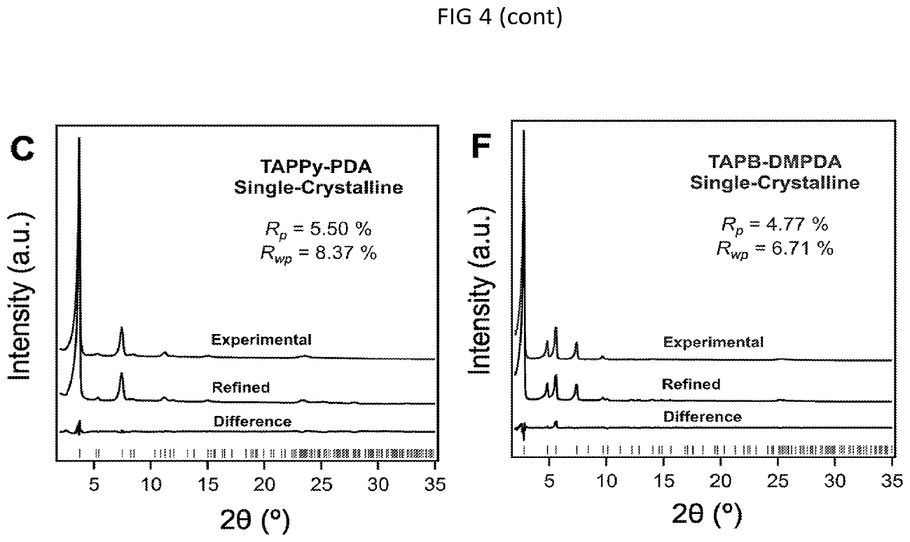

Continuous rotation electron diffraction (cRED) was used to elucidate the unit cells of TAPPy-PDA and TAPB-DMPDA COF single crystals (FIG. 4A-D). The cRED data was collected at a low dose mode at 99 K on a JEOL 2100-plus TEM and equipped with a MerlinEM direct electron detector under 200 kV. For the TAPPy-PDA COF, 178 electron diffraction (ED) patterns were collected with the tilting angle ranging from −55.07° to 44.52°. Data collection for the TAPB-DMPDA COF was conducted similarly except for 156 out of 178 ED patterns which were collected with the tilting angle ranging from −39.86° to 48.04°. Each frame was collected with an exposure time of 0.750 s, resulting in a 0.560 wedge per frame. The three-dimensional (3D) reciprocal space was reconstructed using the program REDp.

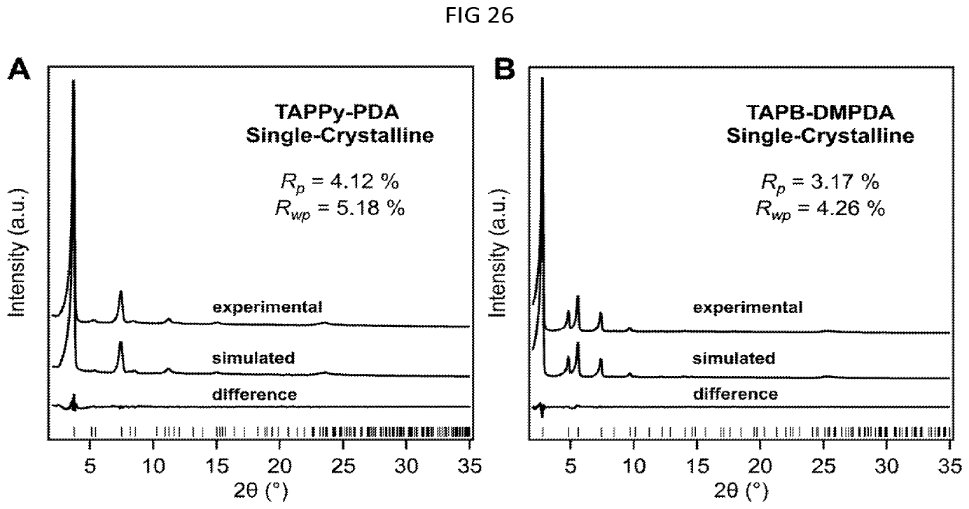

FIGS. 4B and E show an obvious series of streaks along the c* axis, which indicates that the crystals of both COFs are ordered in the a-b plane but disordered in the stacking dimension. The unit cell of the TAPPy-PDA COF was determined as a monoclinic C-lattice with a=32.52 Å, b=34.36 Å, β=85.77°. For TAPB-DMPDA COF, the diffraction data could be indexed by a hexagonal P-lattice with a=35.47 Å, b=35.48 Å. Based on the unit cells determined by REDp, initial structure models were built using the Materials Studio software package, and their simulated PXRD patterns fitted well with the experimental ones. The results of Pawley refinements showed low residuals of Rₚ and R_{wp} as well as excellent agreement with the experimental PXRD patterns in the peak positions and relative intensities (FIG. 26). Finally, more accurate structure models were obtained by the Rietveld refinement (space group: C2/m for TAPPy-PDA COF with a=32.545(2) Å, b=34.286(8) Å, c=3.846(2) Å, α=γ=90°, and β=85.371(6°); space group: P6 for TAPB-DMPDA COF with a=b=36.358(9) Å, c=3.5127(8) Å, α=γ=90°, and β=120°; The Rietveld refinements for both COFs show low R_{wp} and Rₚ values, 8.37% and 5.50%; 6.71% and 4.77% for TAPPy-PDA and TAPB-DMPDA COFs, respectively, which helps us rationalize the interlayer structures.

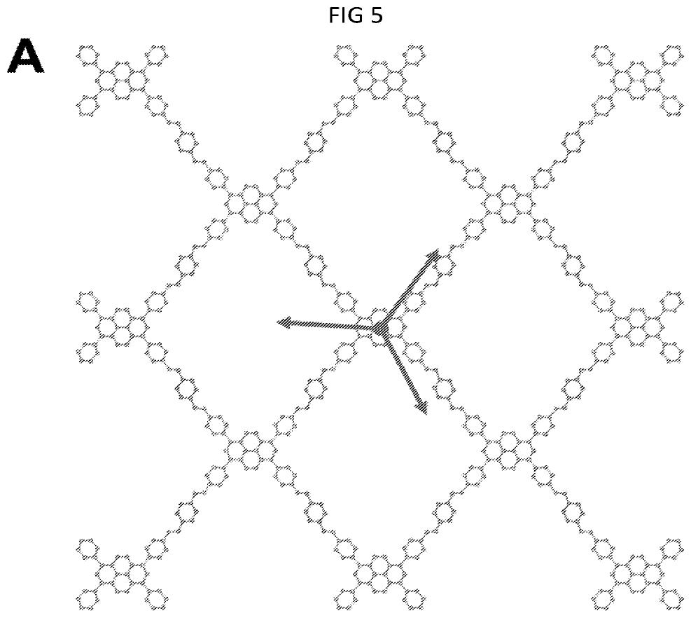

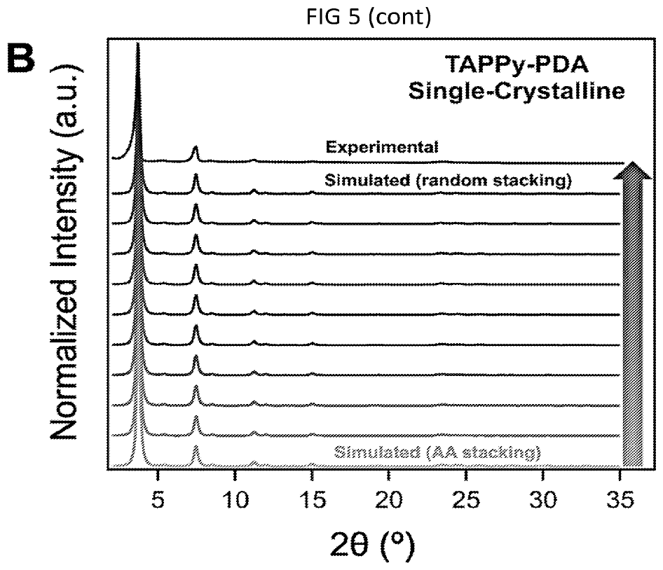

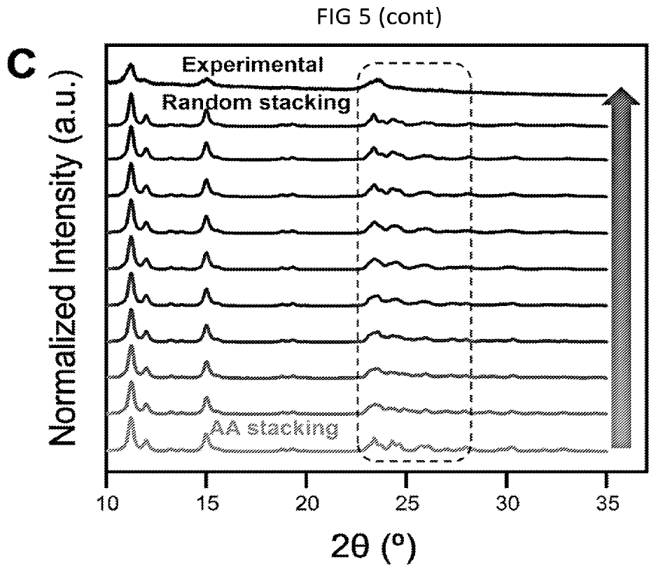

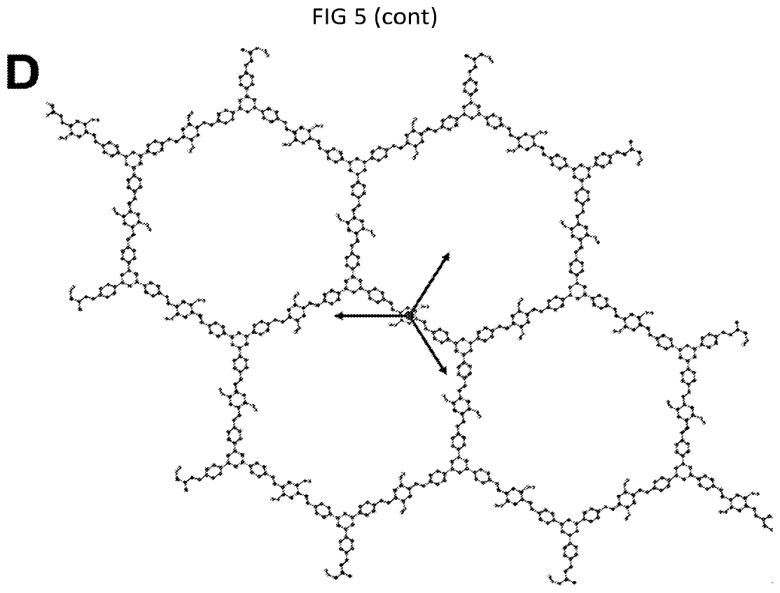

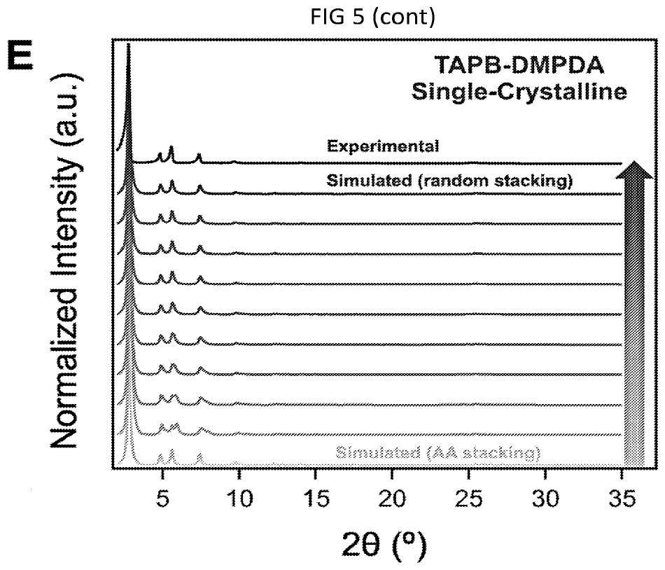

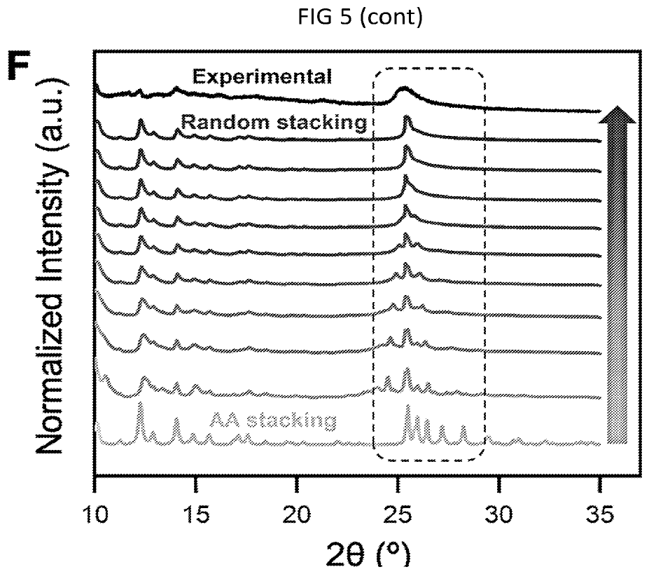

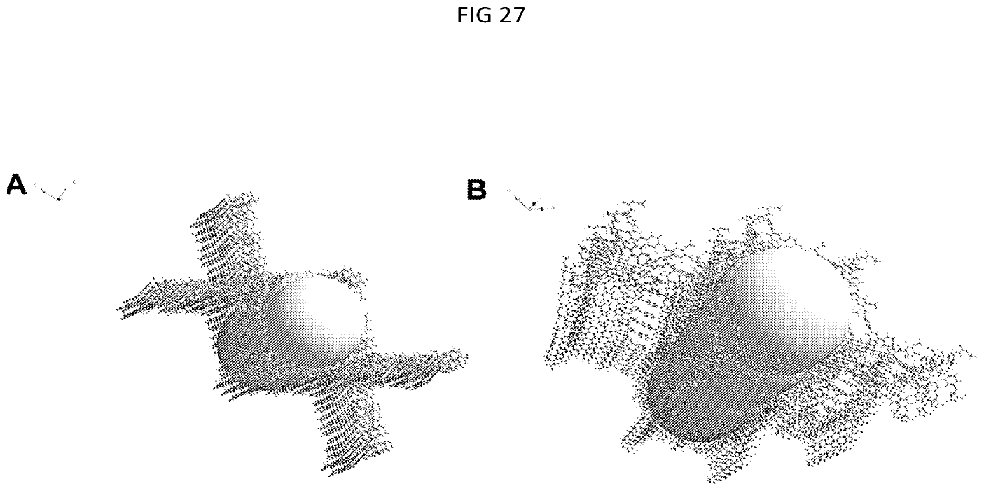

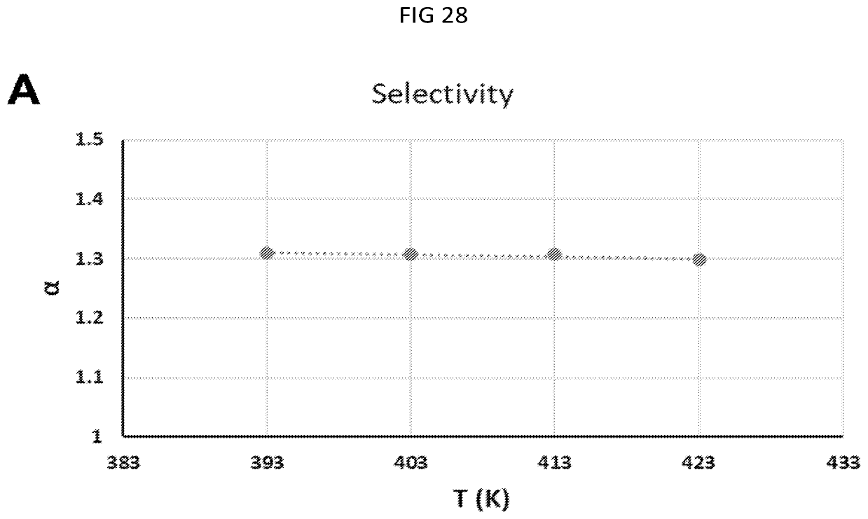

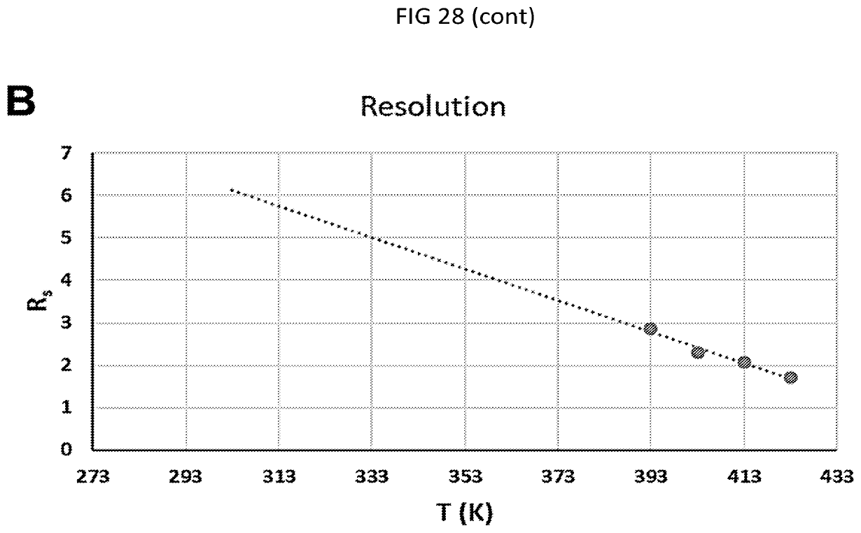

Due to the high surface areas and large interfacial energies of both the TAPPy-PDA and TAPB-DMPDA COFs, it is possible that the layers may be slip-stacked with respect to each other to minimize the free energy. Most 2D COFs contain varying degrees of stacking disorder, and only rarely do they exist as single crystals with perfectly eclipsed AA stacking. In the recent report of the TAPPy-PDA COF single crystals synthesized by Zhao and coworkers, only about 10% of the crystals adopt a fully eclipsed structure, whereas almost 90% of the crystals adopt a structure containing 6 different stacking layers within one unit cell.⁶⁰ In general, the disordered stacking in 2D COFs is the primary reason why their crystal structures cannot be solved directly even when their individual 2D polymer sheets are single crystals with micron-scale lateral dimensions. To further understand the nature of the stacking disorder in our TAPPy-PDA and TAPB-DMPDA COF crystals, DIFFaX modeling was performed to simulate the PXRD patterns of different stacking scenarios. For both the TAPPy-PDA and TAPB-DMPDA COFs, we used three different offset directions and distances (FIGS. 5A and D). Zhao and coworkers have recently solved the accurate structure of TAPPy-PDA COF single crystal, from which we obtained the offset distance of 0.36 Å. However, the structure of the TAPB-DMPDA COF has not yet been solved. Lotsch and coworkers have proposed an optimum stacking offset of 1.6 Å for this COF from density functional theory (DFT) calculations. Using these insights, we simulated the stacking of both the TAPPy-PDA and TAPB-DMPDA COFs, going gradually from fully eclipsed (AA) to random stacking (FIGS. 5B and D). The experimental PXRD patterns of the TAPPy-PDA and TAPB-DMPDA COFs (top traces, FIGS. 5B and D) are similar to those of the AA stacking (bottom traces, FIGS. 5B and D) on hk0 reflections. However, when compared to the AA stacking trace, the (001) stacking reflections in the experimental PXRD patterns are weaker and more widened significantly, which suggests that the real COF structure likely does not adopt AA stacking. The experimental (001) stacking reflections fit best when the stacking becomes close to a random model. In addition, we simulated 18 randomly stacked layers and calculated the diameters of the biggest spheres that can traverse the pores created by this arrangement (FIG. 27, Table 2) to obtain average pore sizes of 23.27 Å and 34.26 Å for the TAPPy-PDA and TAPB-DMPDA COFs, respectively. These are in good agreement with the pore sizes obtained from NLDFT analysis of the BET isotherms of the two COFs (FIGS. 2C and F). Taken together, these electron diffraction results provide critical insight into the structures of the TAPB-DMPDA and TAPPy-PDA COFs, suggesting that the materials are single-crystalline in the a-b planar dimensions but disordered in the stacking c dimension. We speculate that this behavior is common among most 2D COFs, and establishes the design of specific and directional interlayer interactions as an important frontier when materials with precise structures in all three dimensions are desired. This behavior, however, is otherwise likely to impact most or all 2D COFs that are not engineered specifically to be ordered along the stacking direction.

### Gas Chromatography Separation of Benzene and Cyclohexane

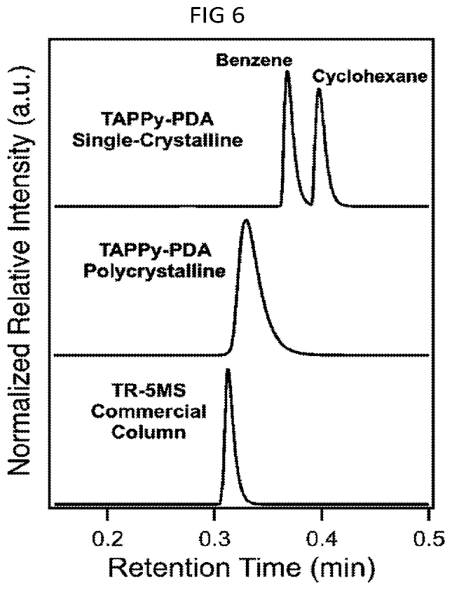

Having isolated high-quality samples of TAPPy-PDA COF, we explored its properties as a stationary phase for the difficult gas chromatographic separation of benzene and cyclohexane. A capillary column (20 μm long, 0.25 mm i.d.) was coated with solutions of either TAPPy-PDA COF single crystals or polycrystalline TAPPy-PDA COF colloids. The columns containing single crystals exhibited excellent separation of a binary (50:50) mixture of benzene and cyclohexane with an unusual preferential adsorption of cyclohexane over benzene, as characterized by their respective retention times (FIG. 6). In contrast, no separation of the benzene/cyclohexane mixture was observed under the same conditions on an identical column coated with polycrystalline TAPPy-PDA COF (FIG. 6). Further optimization of the GC parameters did not identify other conditions where the polycrystalline COF separated the two analytes (Table 7). Likewise, a commercially available capillary column of similar dimensions, TR-5MS (made of 5% phenyl polysiloxane), did not show any separation of the adsorbates (FIG. 6).

In the column coated with polycrystalline TAPPy-PDA COF, no separation was discernible, suggesting that the polycrystalline COF pores were not as accessible to the adsorbates compared to the single crystals. We speculate that most of the interactions between the adsorbates and the polycrystalline TAPPy-PDA COF occurred on the outer surface of the 2D structure and not within the pores, where cyclohexane may exhibit preferential non-covalent interactions with groups on the pore walls. Taken together, these observations suggested the domination of an interpenetrated network structure within the polycrystalline TAPPy-PDA COF, leading to stronger adsorption interactions than those of the single-crystalline TAPPy-PDA COF.

TABLE 1
Enthalpy (ΔH_{A}), entropy (ΔS_{A}), and Gibbs free
energy (ΔG_{A}) of adsorption of benzene and cyclohexane
on single-crystalline and polycrystalline TAPPy-PDA
COF-coated columns. Data recorded at 423 K and 0.2 MPa.

| | |
|---|---|
| Single-crystalline | Polycrystalline |

−ΔH_{A} (kJ mol⁻¹)

| | | |
|---|---|---|
| Benzene | 46.95 ± 0.34 | 58.97 ± 0.76 |
| Cyclohexane | 47.33 ± 0.69 | 58.97 ± 0.76 |

−ΔS_{A} (kJ mol⁻¹)

| | | |
|---|---|---|
| Benzene | 56.23 ± 1.41 | 86.94 ± 1.87 |
| Cyclohexane | 55.44 ± 1.05 | 87.39 ± 1.87 |

−ΔG_{A} (kJ mol⁻¹)

| | | |
|---|---|---|
| Benzene | 23.16 ± 0.07 | 22.19 ± 0.04 |
| Cyclohexane | 23.88 ± 0.06 | 22.00 ± 0.04 |

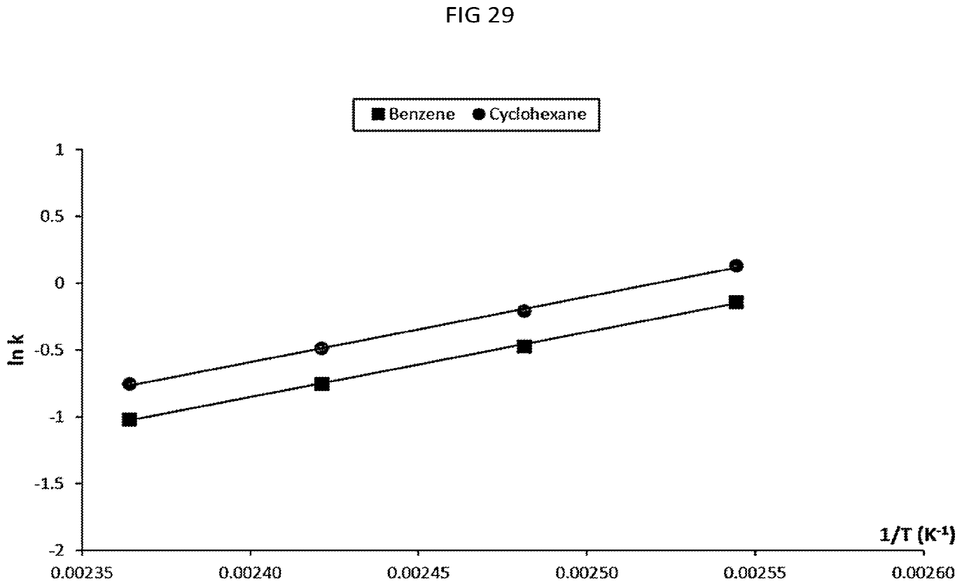

The reversed adsorption selectivity for cyclohexane over benzene observed for the single-crystalline TAPPy-PDA COF (FIG. 6) is unusual and motivated further investigation. Adsorbents with pore widths in the range of 7-10 Å have been reported to exhibit this reversed selectivity, but the 2.3 nm-sized pores (FIG. 2C) of the TAPPy-PDA COF are too large to operate by a size sieving mechanism for these analytes. The adsorption enthalpy (ΔH_{A}) and adsorption entropy (ΔS_{A}) were calculated using an inverse gas chromatography (IGC) study performed at varying temperatures and constant pressure. The linear relations in the Van't Hoff plots (FIG. 29) indicated that there was no change in the mechanism of interaction over the measured temperature range (393-423 K). Furthermore, the negative values of the Gibbs free energies of adsorption (ΔG_{A}) suggest spontaneous transfer of the adsorbates from the stationary to the mobile phase (Table 1 and 7). The ΔG_{A} values of cyclohexane molecules (−23.88±0.06 kJ mol⁻¹) in the column coated with TAPPy-PDA COF single crystals were more negative than those of the benzene molecules (−23.16±0.07 kJ mol⁻¹; Table 1), and this difference was determined to be significant by a statistical t-test at 95% confidence interval. The ΔG_{A} values of both adsorbates were more negative in the column coated with TAPPy-PDA COF single crystals (−23.88±0.06 kJ mol⁻¹ and −23.16±0.07 kJ mol-1 for cyclohexane and benzene, respectively) than its polycrystalline-COF-coated counterpart (−22.00±0.04 kJ mol⁻¹ and −22.19±0.04 kJ mol⁻¹ for cyclohexane and benzene, respectively; Table 1), and this difference was also statistically significant at the 95% confidence interval. Although the ΔG_{A} values for benzene molecules (−22.19±0.04 kJ mol⁻¹) in the polycrystalline-COF-coated column were more negative than those of the cyclohexane (−22.00±0.04 kJ mol⁻¹), this difference was not statistically significant, corresponding to the lack of separation of benzene and cyclohexane adsorbates in this column. Considering the Gibbs free energy of adsorption (ΔG_{A}) as a function of the adsorption density, these observations supported outer-surface interactions—mainly π . . . π host-guest interactions with the aromatic ring-being predominant in the case of the polycrystalline TAPPy-PDA COF coated column.

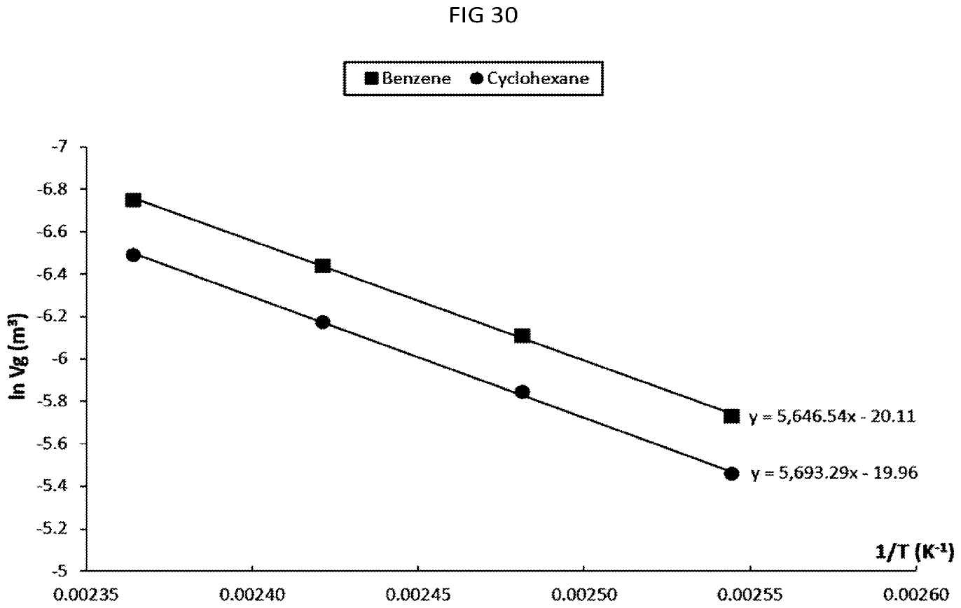

Additionally, adsorption enthalpies (ΔH_{A}) were determined from the slope of In V_{g} plotted as a function of T⁻¹ (FIG. 30), where the linear dependence implied a constant value of ΔH_{A} in the range of measured temperatures (393-423 K). For both the single-crystalline and polycrystalline TAPPy-PDA COFs, the enthalpies of adsorption of benzene and cyclohexane were more negative than the enthalpy of liquefication (ΔH_{liq}; Table 8), indicating that the adsorbate-adsorbent interactions were stronger than adsorbate-adsorbate interactions. The small difference between the enthalpies of adsorption and liquefication for benzene and cyclohexane also suggested that the predominant interactions across the interface stemmed from the secondary weak intermolecular forces or Liftshitz-van der Waals forces. Thus, the surfaces of both TAPPy-PDA COF materials seemed to be energetically homogeneous towards the adsorption of benzene and cyclohexane.

Despite the preferential adsorption of cyclohexane on the single-crystalline TAPPy-PDA COF coated column, the more negative value of the ΔH_{A} of cyclohexane was not statistically significant, indicating no enthalpic preference between the adsorbates. The calculated values of ΔH_{A} of benzene and cyclohexane in the column coated with TAPPy-PDA COF single crystals were −46.95±0.34 kJ mol⁻¹ and −47.33±0.69 kJ mol⁻¹, respectively, at 95% confidence level (Table 1). However, the entropy of adsorption (ΔS_{A}) of benzene on the column coated with TAPPy-PDA COF single crystals at 393 K (−56.23±1.41 J mol⁻¹ K⁻¹) was significantly more negative than that of cyclohexane (−55.44±1.25 J mol⁻¹K⁻¹; Table 1) as determined by a statistical t-test at 95% confidence level, indicating that cyclohexane molecules maintained more conformational freedom than the benzene molecules in the pores of the single crystals.

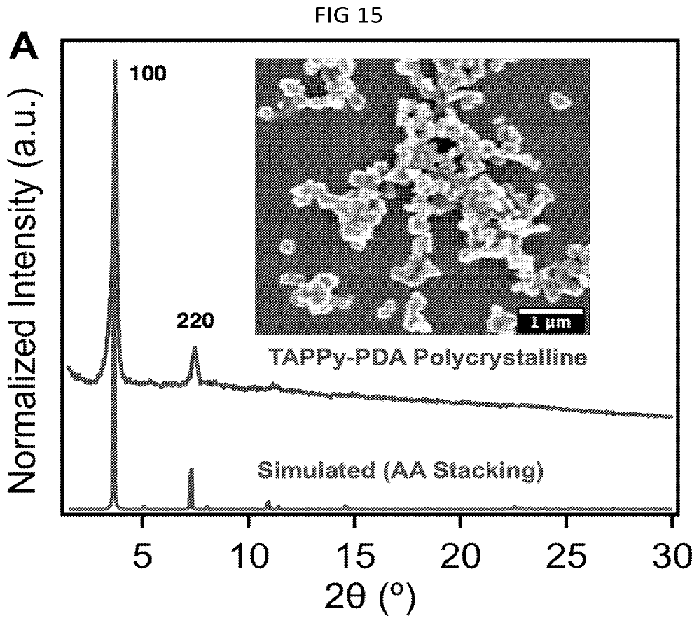

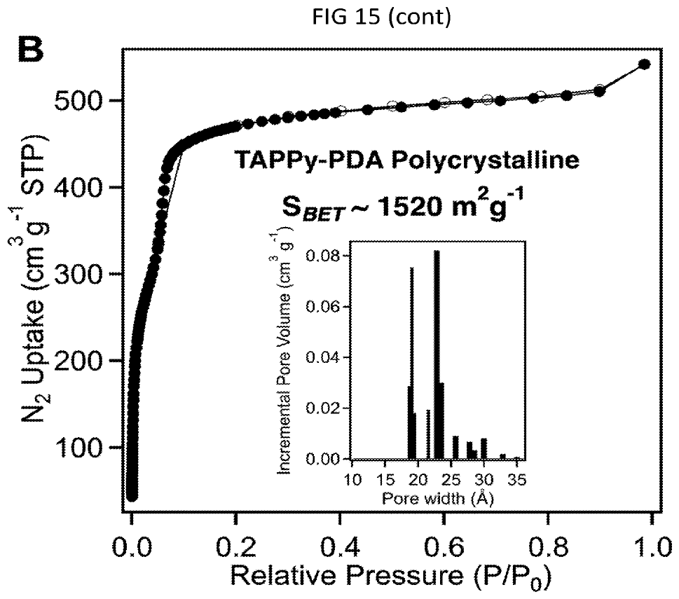

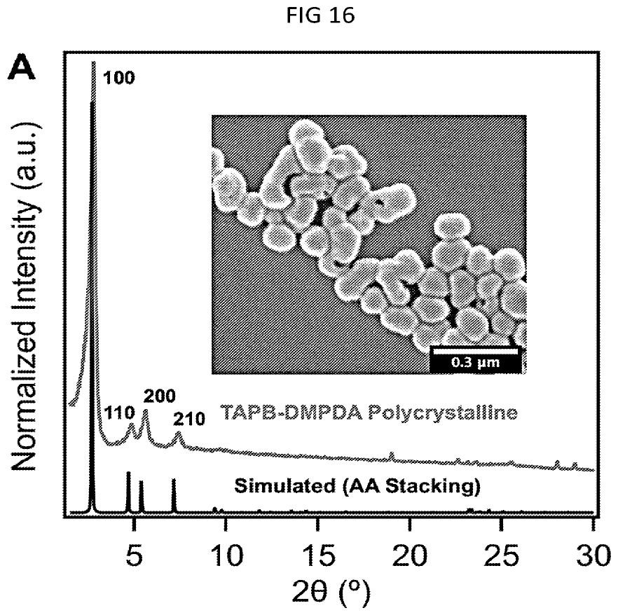

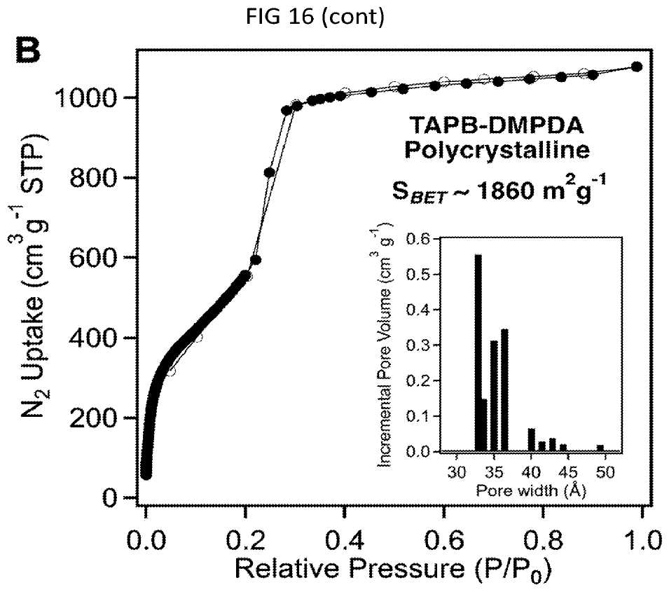

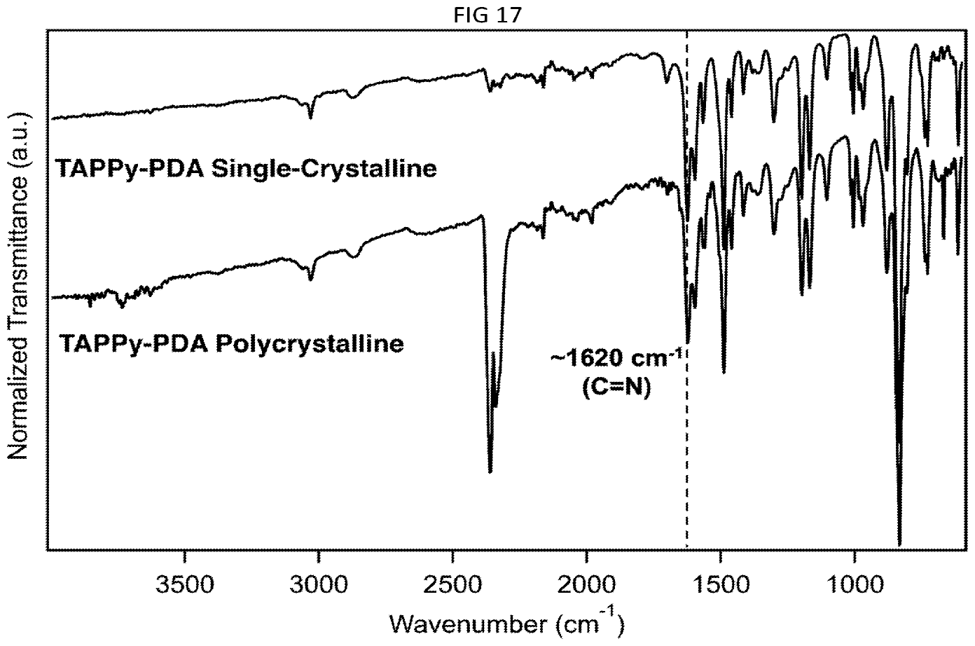

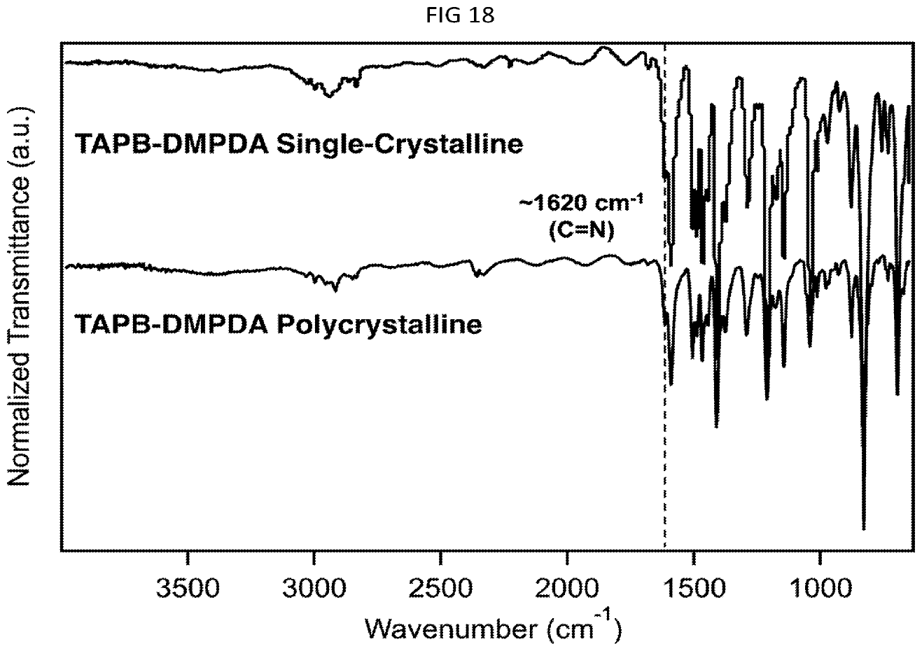

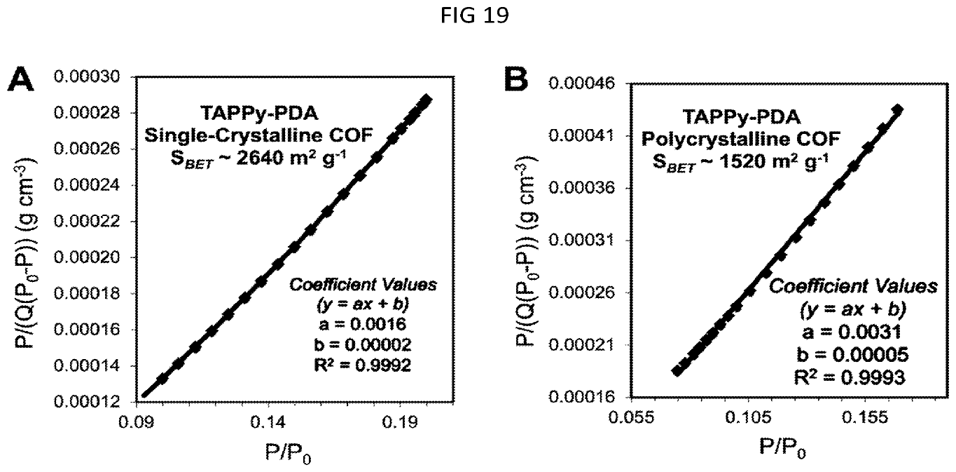

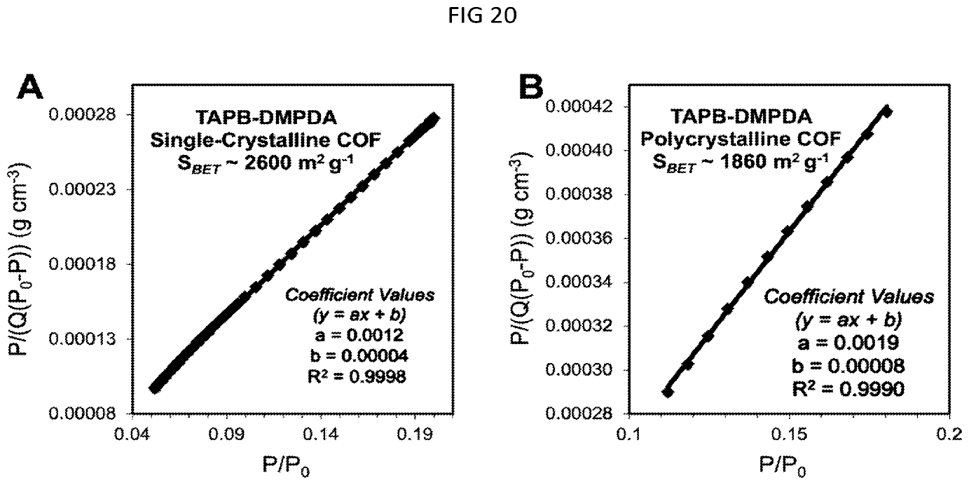

Additionally, the absolute values of the ΔH_{A} and ΔS_{A} of both benzene and cyclohexane molecules on the column coated with polycrystalline TAPPy-PDA COF were greater than their counterparts on the column coated with TAPPy-PDA COF single crystals, despite the polycrystalline COF having a significantly lower accessible BET surface area (FIG. 15). Although the equilibrium constants (Henry's constants; Table 5) for the polycrystalline TAPPy-PDA COF were lower because of its lower accessible BET surface area, the adsorption preference was related only to the energetics of the adsorption sites. Thus, cyclohexane molecules seem to have an entropic advantage over benzene molecules in being adsorbed into the COF pores, which we attribute to confirmational flexibility and greater rotational freedom.

### CONCLUSIONS

The Examples demonstrate the synthesis of single-crystalline 2D imine-linked COF crystals of two topologies: a square COF and a hexagonal COF. Exploration of the polymerization conditions identified the monomer concentration, modulator loadings and reaction temperature as important factors to increase the sizes of TAPPy-PDA and TAPB-DMPDA COFs from 720 nm to 4 μm and 450 nm to 20 μm lateral dimensions, respectively. All the COF crystals reported here exhibit excellent crystallinity and porosity, as determined from PXRD and N₂ adsorption isotherms, are faceted, as characterized by SEM and HRTEM imaging, and are single-crystalline in two dimensions, as corroborated by cRED characterization. 2D polymers have yet to be explored systematically for separation applications, although they offer many desirable attributes for these applications. The COF single crystals showed efficient gas chromatography separation of benzene and cyclohexane, two industrially important organic molecules that are challenging and energetically expensive to separate by conventional distillation. Taken together, these results demonstrate a novel synthetic strategy in which large, single-crystalline 2D imine-linked COFs are prepared in a highly facile and versatile manner and used towards a targeted separation application.

### Examples

### Materials and Instrumentation

Materials. Reagents were purchased in reagent grade from commercial suppliers and used without further purification, unless otherwise described. High-purity grade (99.9999%) gases (air, helium, hydrogen, nitrogen, and methane) were purchased from SIGAS (Riyadh, Saudi Arabia). Cyclohexane and benzene were supplied by BDH (Lutterworth, UK).

Instrumentation. The supercritical CO₂ drying was performed on Leica EM CPD 300. Prior to the supercritical drying process, all samples were placed in tea bags (ETS Drawstring Tea Filters, sold by English Tea Store) while wet. The tea bags containing the samples were then placed in the drying chamber. The drying chamber was first sealed, cooled, and filled with liquid CO₂, and after 2 min, the samples were vented quickly. This fill-vent cycle was repeated 99 times, after which the temperature was raised to 40° C. resulting in a chamber pressure of around 1300 psi, which is well above the critical point of CO₂. The chamber was held above the critical point for 5 min, after which the CO₂ source was turned off, and the pressure was released over a period of 5 min.

Powder X-ray diffraction (PXRD) patterns were obtained at room temperature on a STOE-STADIMP powder diffractometer equipped with an asymmetric curved Gennanium monochromator (Cu Kα₁ radiation, λ=1.54056 Å) and one-dimensional silicon strip detector (MYTHEN2 1K from DECTRIS). The line focused Cu X-ray tube was operated at 40 kV and 40 mA. The as-obtained powder samples were sandwiched between two acetate foils (polymer sample with neither Bragg reflections nor broad peaks above 2θ=10°) mounted in flat plates with a disc opening diameter of 8 mm and measured in transmission geometry in a rotating holder. The patterns were recorded in the 20 range of 0-32° for an overall exposure time of 24 min. The instrument was calibrated against a NIST Silicon standard (640d) prior to the measurement.

Gas adsorption isotherms were conducted on a Micromeritics ΔSAP 2420 Accelerated Surface Area and Porosity Analyzer using 15-50 mg samples in dried and tared analysis tubes equipped with filler rods and capped with a Transeal. Samples were heated to 40° C. at a rate of 1° C./min and evacuated at 40° C. for 20 min, then heated to 100° C. at a rate of 1° C./min heat and evacuated at 100° C. for 18 h. After degassing, each tube was weighed again to determine the mass of the activated sample and transferred to the analysis port of the instrument. UHP-grade (99.999% purity) N₂ was used for all adsorption measurements. N₂ isotherms were generated by incremental exposure to nitrogen up to 760 mmHg (1 atm) in a liquid nitrogen (77 K) bath. Oil-free vacuum pumps and oil-free pressure regulators were used for all measurements. Brunauer-Emmett-Teller (BET) surface areas were calculated from the linear region of the N₂ isotherm at 77 K within the pressure range P/P₀ of 0.05-0.20. Pore size distributions were analyzed using non-localized density functional theory (NLDFT) analysis on the MicroActive software using a model of N₂ at 77K being adsorbed and desorbed into cylindrical pores in a carbon surface single-walled nanotube (SWNT).

Scanning electron microscopy (SEM) images of TAPPy-PDA and TAPB-DMPDA COFs were taken on a Hitachi S4800 cFEG SEM. The samples were coated with 18 nm of osmium tetroxide using an SPI OPC-60A osmium plasma coater.

Atomic force microscopy (AFM) images were collected using a Bruker Dimension Fastscan AFM in tapping mode.

High-resolution transmission electron microscopy (HRTEM) of the COF crystals was performed using a JEOL (JEOL USA, Inc., Peabody, MA) ARM300F GrandARM TEM operating at 300 keV equipped with a Gatan (Gatan, Inc., Pleasanton, CA) K3-IS “direct electron” detector (FEG Emission: 15 μA, spot size 5, 150 μm CL aperture). The ARM300F was aligned for low-dose imaging, measuring the dose rate on the K3 detector through vacuum (no grid inserted). The dose rate used was 0.61 e⁻Å⁻² s⁻¹ for low magnification images (5760×4092 pixels, binning 2), with an image exposure time of 1 s (0.61 e⁻Å⁻² cumulative dose per image). All image acquisition was done using the Gatan Microscopy Suite (GMS), Digital Micrograph (Gatan, Inc., Pleasanton, CA).

cRED data was collected with a low dose of electrons at 99 K on a JEOL 2100-plus TEM equipped with MerlinEM direct electron detector under 200 kV. There were 178 ED patterns collected for the TAPPy-PDA COF with the tilting angle ranging from −55.07° to 44.52°. Each frame was collected with an exposure time of 0.750 s, resulting in a 0.56° wedge per frame. The three-dimensional (3D) reciprocal space was reconstructed using the REDp software. 156 ED patterns for the TAPB-DMPDA COF were collected under the same conditions, except, the tilting angle ranged from −39.86° to 48.04°.

A Shimadzu 2025 Series gas chromatograph equipped with FID was used for the gas chromatography (GC) measurements. Fused silica capillaries (20 μm long×0.25 mm i.d.) (CM Scientific, Silsden, United Kingdom) were treated according to the following recipe before dynamic coating: each capillary was washed with 1 M NaOH for 2 h, ultrapure water for 30 min, 0.1 M HCl for 2 h, and ultrapure water until the outflow reached pH 7.0. The capillary was purged with nitrogen at 423 K to be dried overnight. TAPPy-PDA COF (single crystals or polycrystalline colloids) were coated onto the pre-treated capillary column via a dynamic coating method¹, and characterized by SEM. Briefly, a 1 mL ethanol suspension of TAPPy-PDA COF (2 mg mL⁻¹) was first filled into the capillary column under gas pressure, and then pushed through the column at a velocity of 40 cm min⁻¹ to leave a wet coating layer on the inner wall of the capillary column. To avoid acceleration of the solution, a plug near the end of the column in the form of a 1 μm long buffer tube was attached to the capillary column end as a restrictor. After coating, the capillary column settled for 2 h for conditioning under nitrogen. Further conditioning of the capillary column was carried out using a temperature program: 303 K for 10 min, ramp from 303 K to 573 K at a ramp rate of 3 K min⁻¹ and 573 K for 30 min. The temperature program was repeated 3 times. The precise mass of the TAPPy-PDA COF coated in the column was determined from the mass difference between the coated capillary column and empty capillary. To avoid detector contamination, the outlet of the column was not connected to the detector during this treatment period.

### Synthetic Procedures

### Single-Crystalline COFs:

TAPPy-PDA Single-Crystalline COF (720 nm-1.3 μm): A 40 mL scintillation vial was charged with benzoic acid (0.938 g, 7.7 mmol) and benzonitrile (4.43, 4.37, 4.31 mL, or 4.26 mL to ensure that the total reaction volume was 6.0 mL after accounting for the volumes of monomer and aniline stock solutions). The vial was capped and heated to 90° C. until all of the benzoic acid had fully dissolved in solution. The vial was uncapped and a stock solution of terephthalaldehyde (PDA, 12 mg (0.089 mmol) in 0.5 mL benzonitrile) was added using a micropipette. Immediately after the addition of the PDA was added aniline using a micropipette (0.570, 0.630, 0.690 or 0.740 mL of 0.7 M stock solution in benzonitrile corresponding to 1.0, 1, 1, 1.2 or 1.3 equiv. aniline per aldehyde functional group, respectively). Finally, immediately after the addition of aniline was added a stock solution of 1,3,6,8-tetrakis(4-aminophenyl)pyrene (TAPPy, 28 mg (0.050 mmol) in 0.5 mL benzonitrile). The scintillation vial was immediately capped without any shaking or stirring and held at 90° C. for 5 minutes, then cooled to room temperature until orange colloids were observed. Aliquots were taken from this reaction mixture and used for SEM, AFM and HRTEM imaging with 10-fold dilution in benzonitrile. Then, the orange colloids were precipitated out by the addition of 1 mL brine and 10 mL methanol, and centrifuged for 10 minutes to obtain the COF as a pellet. The COF pellet was then filtered into a tea bag or dialysis tubing, and washed with methanol in a Soxhlet extractor for 18 h. The material was then activated in a supercritical CO₂ dryer to afford TAPPy-PDA single-crystalline COF as orange solids in isolated yields of 90%.

TAPPy-PDA Single-Crystalline COF (2-4 μm): A 40 mL scintillation vial was charged with benzoic acid (0.938 g, 7.7 mmol) and benzonitrile (4.54, 3.54, or 2.54 mL to ensure that the total reaction volume was 6.0, 5.0, or 4.0 mL, corresponding to [TAPPy]=8, 10, or 12 mM, respectively). The vial was capped, and heated to 100, 110, or 120° C. until all of the benzoic acid had fully dissolved in solution. The vial was uncapped and a stock solution of terephthalaldehyde (PDA, 12 mg (0.089 mmol) in 0.5 mL benzonitrile) was added using a micropipette. Immediately after the addition of PDA was added aniline using a micropipette (0.460 mL of 0.7 M stock solution in benzonitrile corresponding to 1.6 equiv. aniline per aldehyde functional group). Finally, immediately after the addition of aniline was added a stock solution of 1,3,6,8-tetrakis(4-aminophenyl)pyrene (TAPPy, 28 mg (0.050 mmol) in 0.5 mL benzonitrile). The scintillation vial was immediately capped without any shaking or stirring and held at 100, 110 or 120° C. for 48 h, then cooled to room temperature until orange colloids were observed. Aliquots were taken from this reaction mixture and used for SEM, AFM and HRTEM imaging with 10-fold dilution in benzonitrile. Then, the orange colloids were precipitated out by the addition of 1 mL brine and 10 mL methanol, and centrifuged for 10 minutes to obtain the COF as a pellet. The COF pellet was then filtered into a tea bag or dialysis tubing, and washed with methanol in a Soxhlet extractor for 18 h. The material was then activated in a supercritical CO₂ dryer to afford TAPPy-PDA single-crystalline COF as orange solids in isolated yields of 80%.

TAPB-DMPDA Single-Crystalline COF (450 nm-7 μm): A 40 mL scintillation vial was charged with benzoic acid (1.35 g, 11 mmol) and the required volume of benzonitrile to ensure that the total reaction volume was 12.0, 8.0, or 6.0 mL, corresponding to [TAPB]=8, 12, or 16 mM, respectively. The vial was capped, and heated to 90° C. until all of the benzoic acid had fully dissolved in solution. The vial was uncapped and a stock solution of 2,5-dimethoxyterephthalaldehyde (DMPDA, 28 mg (0.144 mmol) in 0.5 mL benzonitrile) was added using a micropipette. Immediately after the addition of DMPDA was added aniline using a micropipette (0.20, 0.30 or 0.40 mL of 0.7 M stock solution in benzonitrile corresponding to 0.4, 0.6 or 0.8 equiv. aniline per aldehyde functional group, respectively). Finally, immediately after the addition of aniline was added a stock solution of 1,3,5-tris(4-aminophenyl)benzene (TAPB, 34 mg (0.096 mmol) in 0.5 mL benzonitrile). The scintillation vial was immediately capped without any shaking or stirring and held at 90° C. for 5 minutes, then cooled to room temperature until red colloids were observed. Aliquots were taken from this reaction mixture and used for SEM, AFM and HRTEM imaging with 10-fold dilution in benzonitrile. Then, the red colloids were precipitated out by the addition of 2 mL brine and 15 mL methanol, and centrifuged for 10 minutes to obtain the COF as a pellet. The COF pellet was then filtered into a tea bag or dialysis tubing, and washed with methanol in a Soxhlet extractor for 18 h. The material was then activated in a supercritical CO₂ dryer to afford TAPB-DMPDA single-crystalline COF as yellow solids in isolated yields of 80%.

TAPB-DMPDA Single-Crystalline COF (10-20 μm): A 40 mL scintillation vial was charged with benzoic acid (1.35 g, 11 mmol) and the required volume of benzonitrile to ensure that the total reaction volume was 8.0, 7.0, or 6.0 mL, corresponding to [TAPB]=12, 14, or 16 mM, respectively. The vial was capped, and heated to 150° C. until all of the benzoic acid had fully dissolved in solution. The vial was uncapped and a stock solution of 2,5-dimethoxyterephthalaldehyde (DMPDA, 28 mg (0.144 mmol) in 0.5 mL benzonitrile) was added using a micropipette. Immediately after the addition of DMPDA was added aniline using a micropipette (0.30, 0.35, or 0.40 mL of 0.7 M stock solution in benzonitrile corresponding to 0.6, 0.7, or 0.8 equiv. aniline per aldehyde functional group, respectively). Finally, immediately after the addition of aniline was added a stock solution of 1,3,5-tris(4-aminophenyl)benzene (TAPB, 34 mg (0.096 mmol) in 0.5 mL benzonitrile). The scintillation vial was immediately capped without any shaking or stirring and held at 150° C. for 48 h, then cooled to room temperature until red colloids were observed. Aliquots were taken from this reaction mixture and used for SEM, AFM and HRTEM imaging with 10-fold dilution in benzonitrile. Then, the red colloids were precipitated out by the addition of 2 mL brine and 15 mL methanol, and centrifuged for 10 minutes to obtain the COF as a pellet. The COF pellet was then filtered into a tea bag or dialysis tubing, and washed with methanol in a Soxhlet extractor for 18 h. The material was then activated in a supercritical CO₂ dryer to afford TAPB-DMPDA single-crystalline COF as yellow solids in isolated yields of 70%.

### Polycrystalline COFs:

TAPPy-PDA Polycrystalline COF: A 40 mL scintillation vial was charged with benzoic acid (0.228 g, 1.9 mmol) and terephthalaldehyde (PDA, 12 mg, 0.089 mmol) in benzonitrile (6 mL) and heated to 90° C. for a few minutes to ensure complete dissolution of each species. To the solution were added, using a micropipette, water (0.120 mL corresponding to 33 equiv. per aldehyde functional group), aniline (0.08 mL of 0.7 M stock in benzonitrile corresponding to 0.28 equiv. per aldehyde functional group), and 1,3,6,8-tetrakis(4-aminophenyl)pyrene (TAPPy, 28 mg, 0.050 mmol). The scintillation vial was immediately capped without any shaking or stirring and held at 90° C. for 3 h, then cooled to room temperature until orange colloids were observed. Aliquots were taken from this reaction mixture and used for SEM imaging with 10-fold dilution in benzonitrile. Then, the red colloids were precipitated out by the addition of 2 mL brine and 15 mL methanol, and centrifuged for 10 minutes to obtain the COF as a pellet. The COF pellet was then filtered into a tea bag and washed with methanol in a Soxhlet extractor for 18 h. The material was then activated in a supercritical CO₂ dryer to afford TAPPy-PDA polycrystalline COF as yellow solids in isolated yields of 90%.

TAPB-DMPDA Polycrystalline COF: A 40 mL scintillation vial was charged with benzoic acid (0.159 g, 1.3 mmol) and 2,5-dimethoxyterephthalaldehyde (DMPDA, 14 mg, 0.072 mmol) in benzonitrile (6 mL) and heated to 90° C. for a few minutes to ensure complete dissolution of each species. To the solution were added, using a micropipette, water (0.095 mL corresponding to 36 equiv. per aldehyde functional group), aniline (0.1 mL of 0.7 M stock in benzonitrile corresponding to 0.28 equiv. per aldehyde functional group), and 1,3,5-tris(4-aminophenyl)benzene (TAPB, 17 mg, 0.048 mmol). The scintillation vial was immediately capped without any shaking or stirring and held at 90° C. for 3 h, then cooled to room temperature until orange colloids were observed. Aliquots were taken from this reaction mixture and used for SEM imaging with 10-fold dilution in benzonitrile. Then, the red colloids were precipitated out by the addition of 2 mL brine and 15 mL methanol, and centrifuged for 10 minutes to obtain the COF as a pellet. The COF pellet was then filtered into a tea bag and washed with methanol in a Soxhlet extractor for 18 h. The material was then activated in a supercritical CO₂ dryer to afford TAPB-DMPDA polycrystalline COF as yellow solids in isolated yields of 80%.

### Gas Chromatography Studies

Chromatographic Setup. Generally, the temperature was raised from 393 to 423 K during inverse-pulse gas chromatography (IGC) measurements. Helium was used as the carrier gas. All probe molecules were used as received without further purification. In order to meet the requirement of adsorption at infinite dilution corresponding to zero coverage and GC linearity, a 1 μL of headspace vapor probe sample was injected for IGC measurements at infinite dilution with a splitting ratio of 30. For each measurement, at least three repeated injections were taken. Methane was used as a marker for the retention time correction.

Inverse-pulse Gas Chromatography Calculations. All of the thermodynamic parameters were derived from the retention volume (V_{N}), which is calculated from the retention time (t_{R}) using Eq. (S1).²

$${V}_{N} = ( {t}_{R} - {t}_{M} ) {F}_{a} \frac{T}{Ta} j \qquad ( S1 )$$

where, t_{M} is the void time estimated from the linear velocity and column dimensions, Fₐ is the flow rate in mL min⁻¹, T is the working temperature, Ta is the ambient temperature (25° C.), and j denotes the James-Martin gas compressibility factor and is calculated as follows:

$$j = \frac{3 ( {P}^{2} - 1 )}{2 ( {P}^{3} - 1 )} \qquad ( S2 )$$

where P is the column pressure over the outlet pressure.³

A specific retention volume (V_{g}) represents a definite value of the material (as a particular guest molecule-material) affected by several factors, including particle size, packing geometry, and temperature, among others. This is considered equivalent to the point of inflection in breakthrough experiments as an example of frontal techniques.^{4,5}

The following relationship (S3) is used to calculate the specific retention volume (V_{g}):

$${V}_{g} = [ \frac{273.15 ( {t}_{R} - {t}_{m} ) {F}_{a} j}{w T} ] [ \frac{( {P}_{o} - {P}_{w} )}{{P}_{w}} ] = 3 / 2 [ \frac{273.15 ( {t}_{R} - {t}_{m} ) {F}_{a} j}{w T} ] \qquad ( S3 )$$

where w represents the mass of the stationary phase, and P_{w} represents the vapor pressure of water at the working temperature, T.

Conventionally, basic IGC equations are derived from V_{g}. However, the retention volume (V_{N}) is very often utilized as well. Additionally, V_{g} can be estimated from the net V_{N} through the following equation.⁶

$${V}_{g} = \frac{{V}_{N} 273.15}{w T} \qquad ( S4 )$$

The slope of the linear isotherm represents Henry's constant (\acute{K}). Henry's constant defines the proportion of carrier gas (Helium) required to elute the maximum concentration of the considered probes through the studied material.

$${K}^{´} = \frac{{V}_{N}}{R T} \qquad ( S5 )$$

The change in enthalpy of adsorption (ΔH_{A}) can be easily obtained by plotting the logarithm of the retention volume, the logarithm-specific retention volume, or Henry's constants gained from isothermal GC measurements versus the inverse temperature. The change in enthalpy of adsorption, ΔH_{A} (also known as the differential heat of adsorption), represents the interaction strength between the adsorbed molecule and the adsorbent atoms at zero surface coverage.

$$Δ {H}_{A} = - R \frac{d in {V}_{N}}{d ( 1 / T )} = - R \frac{d in {V}_{g}}{d ( 1 / T )} \qquad ( S6 )$$

The change in the standard free energy of adsorption, ΔG_{A}, is determined from the V_{N} of the vapor probe using Eq. (S7).⁹

$$Δ {G}_{A} - - RT ln ( \frac{{V}_{N} P °}{m S π 0} ) - - RT ln ( \frac{{V}_{g} P °}{S π 0} ) \qquad ( S7 )$$

where m represents the mass of the adsorbent material in the column, π₀ represents the reference two-dimensional surface pressure, S represents the specific surface area of the adsorbent, and P^{o} represents the vapor pressure of the adsorbate in its gaseous state, which can be estimated using Antoine's equation as follows:

$$Log ( P ° ) = A - ( \frac{B}{t + C} ) \qquad ( S8 )$$

where A, B, and C are the Antoine coefficients obtained from standard reference handbooks and t is the temperature in degrees Celsius.

The change in entropy of adsorption, ΔS_{A}, is calculated at zero Henry surface coverage using the following equation:

$$Δ {S}_{A} = \frac{Δ {H}_{A} - Δ {G}_{A}}{T} \qquad ( S9 )$$

where ΔH_{A} denotes the change in enthalpy of adsorption, ΔG_{A} denotes the change in the standard free energy of adsorption, and T denotes the working temperature.

### REFERENCES

(1) Li, X.; Liu, Y.; Wang, J.; Gascon, J.; Li, J.; Bruggen, B. V. der. Metal-Organic Frameworks Based Membranes for Liquid Separation. Chem. Soc. Rev. 2017, 46, 7124-7144.
(2) Lavielle, L.; Schultz, J. Surface Properties of Carbon Fibers Determined by Inverse Gas Chromatography: Role of Pretreatment. Langmuir 1991, 7, 978-981.
(3) Yuan, S.; Li, X.; Zhu, J.; Zhang, G.; Puyvelde, P. V.; Bruggen, B. V. der. Covalent Organic Frameworks for Membrane Separation. Chem. Soc. Rev. 2019, 48, 2665-2681.
(4) Hosseini Monjezi, B.; Kutonova, K.; Tsotsalas, M.; Henke, S.; Knebel, A. Current Trends in Metal-Organic and Covalent Organic Framework Membrane Materials. Angew. Chem. Int. Ed. 2021, 60, 15153-15164.
(5) Yusuf, K.; Badjah-Hadj-Ahmed, A. Y.; Aqel, A.; Aouak, T.; ALOthman, Z. A. Zeolitic Imidazolate Framework-Methacrylate Composite Monolith Characterization by Inverse Gas Chromatography. J. Chromatogr. A 2016, 1443, 233-240.
(6) Yusuf, K.; Agel, A.; ALOthman, Z. Metal-Organic Frameworks in Chromatography. J. Chromatogr. A 2014, 1348, 1-16.
(7) Yusuf, K.; Shekhah, O.; ALOthman, Z.; Eddaoudi, M. Metal-Organic Frameworks Characterization via Inverse Pulse Gas Chromatography. Appl. Sci. 2021, 11, 10243.
(8) Mukherjee, S.; Sensharma, D.; Qazvini, O. T.; Dutta, S.; Macreadie, L. K.; Ghosh, S. K.; Babarao, R. Advances in Adsorptive Separation of Benzene and Cyclohexane by Metal-Organic Framework Adsorbents. Coord. Chem. Rev. 2021, 437, 213852.
(9) Sholl, D. S.; Lively, R. P. Seven Chemical Separations to Change the World. Nature 2016, 532, 435-437.

### TABLES

TABLE 2
Average pore size of DIFFaX-simulated stacking
of TAPPy-PDA TAPB-DMPDA COF single crystals.

| | Sphere | Pore size | NLDFT pore |
|---|---|---|---|
| | Radius (Å) | (Å) | size (nm) |
| TAPPy-PDA | 11.64 | 23.28 | 2.32 |
| COF | | | |
| TAPB-DMPDA | 17.13 | 34.26 | 3.36 |
| COF | | | |

TABLE 3
Comparison of the physical properties of benzene and cyclohexane

| | | Boiling | Kinetic | | | | |
|---|---|---|---|---|---|---|---|
| | | Point | Diameter | Antoine Coefficients | | | α₀ × 10 |
| Probe | Formula | (K) | (Å) | A | B | C | (Å³) |
| Benzene | C₆H₆ | 353.24 | 5.35-5.85 | 7.06437 | 1296.93 | 229.916 | 100-107.4 |
| Cyclohexane | C₆H₁₂ | 353.93 | 6.00-6.18 | 7.00854 | 1296.23 | 233.309 | 108.7-110 |

(B.P. = boiling point; α₀ = polarizability)

TABLE 4
Variation of vapor pressure of benzene and cyclohexane in
the gaseous standard state (P°) with temperature, in
the temperature range of 423-393 K. Data recorded at 0.2 MPa.

P° (mmHg)

| Probe | 423 K | 413 K | 403 K | 393 K |
|---|---|---|---|---|
| Benzene | 4473.4 | 3617.1 | 2890.3 | 2280.2 |
| Cyclohexane | 4235.0 | 3437.7 | 2758.6 | 2186.3 |

TABLE 5
Variation of Henry's constants (\acute{K}) of benzene and cyclohexane
with temperature, on single-crystalline and polycrystalline TAPPy-PDA COF-
coated columns, in the temperature range of 423-393 K. Data recorded at 0.2 MPa.

| | 10⁴ × \acute{K} (mole kg−¹ Pa−¹) | | | | | | | |
|---|---|---|---|---|---|---|---|---|
| | TAPPy-PDA single-crystalline | | | | TAPPy-PDA polycrystalline | | | |
| Probe | 423 K | 413 K | 403 K | 393 K | 423 K | 413 K | 403 K | 393 K |
| Benzene | 3.32 | 4.65 | 6.62 | 9.94 | 1.35 | 1.93 | 3.12 | 5.16 |
| Cyclohexane | 4.31 | 6.08 | 8.65 | 13.0 | 1.35 | 1.93 | 3.12 | 5.16 |

TABLE 6
Variation of the specific retention volume (V_{g}) of benzene and cyclohexane
with temperature, on single-crystalline and polycrystalline TAPPy-PDA
COF-coated columns, in the range of 423-393 K. Data recorded at 0.2 MPa.

| | V_{g} (L g⁻¹) | | | | | | | |
|---|---|---|---|---|---|---|---|---|
| | TAPPy-PDA single-crystalline | | | | TAPPy-PDA polycrystalline | | | |
| Probe | 423 K | 413 K | 403 K | 393 K | 423 K | 413 K | 403 K | 393 K |
| Benzene | 1170 | 1600 | 2220 | 3250 | 474 | 664 | 1050 | 1690 |
| Cyclohexane | 1520 | 2090 | 2900 | 4260 | 474 | 664 | 1050 | 1690 |

TABLE 7
Variation in the free energy change of adsorption (ΔG_{A}) of benzene and
cyclohexane with temperature, on single-crystalline and polycrystalline
TAPPy-PDA COF-coated columns, in the temperature range of 423-393 K. Data
recorded at 0.2 MPa. The error is based on the 95% confidence interval.

| | −ΔG_{A} (kJ mol⁻¹) | | | | | | | |
|---|---|---|---|---|---|---|---|---|
| | TAPPy-PDA single-crystalline | | | | TAPPy-PDA polycrystalline | | | |
| Probe | 423 K | 413 K | 403 K | 393 K | 423 K | 413 K | 403 K | 393 K |
| Benzene | 23.1 ± | 22.9 ± | 22.8 ± | 22.6 ± | 22.2 ± | 22.1 ± | 22.3 ± | 22.6 ± |
| | 0.07 | 0.06 | 0.02 | 0.02 | 0.04 | 0.03 | 0.22 | 0.04 |
| Cyclohexane | 23.9 ± | 23.7 ± | 23.5 ± | 23.4 ± | 22.0 ± | 21.9 ± | 22.1 ± | 22.4 ± |
| | 0.06 | 0.02 | 0.03 | 0.02 | 0.04 | 0.03 | 0.22 | 0.04 |

TABLE 8
Change in enthalpy of adsorption (ΔH_{A}) and change in
enthalpy of liquification (ΔH_{liq}) of benzene and cyclohexane,
on single-crystalline and polycrystalline TAPPy-PDA COF-coated
columns, at 423 K. Data recorded at 0.2 MPa. The error
is based on the 95% confidence interval.

| | −ΔH_{A} (kJ mol⁻¹) | | |
|---|---|---|---|
| | TAPPy-PDA | TAPPy-PDA | −ΔH_{liq} |
| Probes | single-crystalline | polycrystalline | (kJ mol⁻¹) |
| Benzene | 47.06 ± 0.34 | 58.87 ± 0.76 | 33.8 |
| Cyclohexane | 47.51 ± 0.69 | 58.87 ± 0.76 | 33.0 |

TABLE 9
Variation of the change in entropy of adsorption (ΔS_{A}) of benzene and
cyclohexane with temperature, on single-crystalline and polycrystalline
TAPPy-PDA COF-coated columns, in the temperature range of 423-393 K and
a pressure of 0.2 MPa. The error is based on the 95% confidence interval.

| | −ΔS_{A} (J mol⁻¹ K⁻¹) | | | | | | | |
|---|---|---|---|---|---|---|---|---|
| | TAPPy-PDA single-crystalline | | | | TAPPy-PDA polycrystalline | | | |
| Probe | 423 K | 413 K | 403 K | 393 K | 423 K | 413 K | 403 K | 393 K |
| Benzene | 56.6 ± | 58.5 ± | 60.4 ± | 62.2 ± | 86.7 ± | 89.0 ± | 90.8 ± | 92.4 ± |
| | 1.41 | 1.26 | 1.35 | 1.41 | 1.87 | 1.87 | 1.36 | 2.03 |
| Cyclohexane | 55.2 ± | 57.0 ± | 58.9 ± | 60.6 ± | 87.2 ± | 89.4 ± | 91.2 ± | 92.7 ± |
| | 1.05 | 1.20 | 1.31 | 1.25 | 1.87 | 1.87 | 1.36 | 2.03 |

1. A covalent organic framework (COF) platelet having lateral dimensions of at least 400 nm, wherein the COF platelet comprises a multiplicity of crystals of an imine-linked 2D-COF oriented with inter-sheet stacking in a direction out-of-plane with the lateral dimensions and wherein each of the multiplicity of crystals of imine-linked 2D-COF comprise a substantially single-crystalline domain.

2. The COF platelet of claim 1, wherein the imine-linked 2D-COF is a 1,3,6,8-tetrakis(4-aminophenyl)pyrene and terephthalaldehyde (TAPPy-PDA) COF.

3. The COF platelet of claim 1, wherein the imine-linked 2D-COF is a 1,3,5-tris(4-aminophenyl)benzene and 2,5-dimethoxyterephthalaldehyde (TAPD-BMPDA) COF.

4. The COF platelet of claim 1, wherein the COF platelet is characterized by preferential adsorption of cyclohexane over benzene.

5. The COF platelet of claim 1, wherein the COF platelet has lateral dimensions of at least 1000 nm in both lateral directions.

6. A column having a plurality of COF platelets according to claim 1 therein.

7. The column of claim 6, wherein the column is a capillary column.

8. The column of claim 6, wherein the COF platelets are characterized by preferential adsorption of cyclohexane over benzene.

9. The column of claim 6, wherein the imine-linked 2D-COF is a TAPPy-PDA COF.

10. The column of claim 6, wherein the imine-linked 2D-COF is a TAPD-BMPDA COF.

11. A gas chromatograph comprising a sample inlet configured to receive a sample, a detector configured to detect retention times of different components of the sample, and the column according to claim 6 connecting the sample inlet and the detector.

12. The gas chromatograph of claim 11, wherein the COF platelets are characterized by preferential adsorption of cyclohexane over benzene.

13. The gas chromatograph of claim 11, wherein the imine-linked 2D-COF is a TAPPy-PDA COF.

14. The gas chromatograph of claim 11, wherein the imine-linked 2D-COF is a TAPD-BMPDA COF.

15. The gas chromatograph of claim 11, wherein the column is a capillary column.

16. A method for preparing a COF platelet comprising contacting a building unit and a linking group in a nitrile-containing solvent in the presence of a modulator of polymerization and catalyst for defect correction, wherein the building unit comprises a molecular subunit having two or more functional termini that covalently bond via an imine bond with an equal number of linking groups.

17. The method of claim 16, wherein the monofunctional modulator of polymerization and catalyst for defect correction comprises aniline or benzaldehyde.

18. The method of claim 16, wherein the nitrile-containing solvent comprises benzonitrile.

19-23. (canceled)

24. A single crystal of an imine-linked 2D-COF prepared by the method according to claim 16.

25. A method for separating a mixture, the method comprising contacting the mixture with the COF platelet according to claim 1.

26-30. (canceled)
